(19) United States
(12) Patent Application Publication
(10) Pub. No.: US 2023/0354406 A1
(43) Pub. Date: Nov. 2, 2023

(54) PRIORITIZATION RULES FOR UPLINK AND DOWNLINK CHANNELS IN FULL-DUPLEX SYSTEMS

(71) Applicant: QUALCOMM Incorporated, San Diego, CA (US)

(72) Inventors: Qian Zhang, Basking Ridge, NJ (US); Yan Zhou, San Diego, CA (US); Tao Luo, San Diego, CA (US)

(21) Appl. No.: 17/730,970

(22) Filed: Apr. 27, 2022

(51) Int. Cl. H04W 72/12; H04L 5/16

(52) U.S. Cl. CPC H04W 72/1242; H04L 5/16

(57) ABSTRACT

Methods, systems, and devices for wireless communications are described. A user equipment (UE) operating in a half-duplex mode may be scheduled, by a network entity operating in a full-duplex mode, to receive a downlink communication during a symbol period and to transmit an uplink communication during the symbol period, where uplink and downlink channel multiplexing enabled during the symbol period. The UE may then communicate with the network entity during the symbol period via either the downlink communication or the uplink communication in accordance with a prioritization rule associated with the half-duplex mode, where the prioritization rule indicates whether the UE should receive the downlink communication or transmit the uplink communication when the communications are scheduled in the same symbol period and when downlink and uplink channel multiplexing is enabled during the same symbol period.

### FIELD OF TECHNOLOGY

The following relates to wireless communications, including prioritization rules for uplink and downlink channels in full-duplex systems.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

In some wireless communications systems, a network entity may communicate with a UE, where the network entity and the UE may operate in one or more modes. For example, a network entity may operate in a full-duplex mode and the UE may operate in a half-duplex mode. Such mis-matches between duplexing modes at the network entity and the UE may result in complications when scheduling wireless communications at the respective devices.

### SUMMARY

The described techniques relate to improved methods, systems, devices, and apparatuses that support prioritization rules for uplink and downlink channels in full-duplex systems. In particular, aspects of the present disclosure provide prioritization rules used to determine whether a user equipment (UE) operating in a half-duplex mode is to prioritize downlink or uplink communications when the UE is configured or scheduled with overlapping downlink and uplink communications. In particular, a restriction for multiplexing downlink and uplink channels within a resource (e.g., symbol period) may be relaxed or lifted based on a network entity operating in a full-duplex mode so that a bandwidth part (BWP) of the resource may be fully utilized (e.g., by the network entity). In such cases where downlink and uplink channel multiplexing is enabled (e.g., restriction is lifted or disabled), the network entity may configure or schedule overlapping downlink and uplink messages at the UE, and aspects of the present disclosure provide prioritization rules including conditions or rules that enable the network entity and the UE to determine whether the UE is to prioritize the downlink or uplink communication.

A method for wireless communications at a UE is described. The method may include receiving, from a network entity, first control signaling scheduling a downlink communication during a symbol period, where the UE is configured to operate in a half-duplex mode during the symbol period, receiving, from the network entity via the first control signaling, second control signaling, or both, an indication of an uplink communication scheduled during the symbol period, and communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

An apparatus for wireless communications at a UE is described. The apparatus may include a processor, memory coupled with the processor, and instructions stored in the memory. The instructions may be executable by the processor to cause the apparatus to receive, from a network entity, first control signaling scheduling a downlink communication during a symbol period, where the UE is configured to operate in a half-duplex mode during the symbol period, receive, from the network entity via the first control signaling, second control signaling, or both, an indication of an uplink communication scheduled during the symbol period, and communicate with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Another apparatus for wireless communications at a UE is described. The apparatus may include means for receiving, from a network entity, first control signaling scheduling a downlink communication during a symbol period, where the UE is configured to operate in a half-duplex mode during the symbol period, means for receiving, from the network entity via the first control signaling, second control signaling, or both, an indication of an uplink communication scheduled during the symbol period, and means for communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

A non-transitory computer-readable medium storing code for wireless communications at a UE is described. The code may include instructions executable by a processor to receive, from a network entity, first control signaling scheduling a downlink communication during a symbol period, where the UE is configured to operate in a half-duplex mode during the symbol period, receive, from the network entity via the first control signaling, second control signaling, or both, an indication of an uplink communication scheduled during the symbol period, and communicate with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Some examples of the method, apparatuses, and non-transitory computer-readable medium described herein may further include operations, features, means, or instructions for receiving the downlink communication based least in part on the prioritization rule indicating to receive the downlink communication that may be a reference signal when the reference signal may be scheduled in the same symbol period as the uplink communication.

Some examples of the method, apparatuses, and non-transitory computer-readable medium described herein may further include operations, features, means, or instructions for receiving, from the network entity, a message indicating the prioritization rule.

In some examples of the method, apparatuses, and non-transitory computer-readable medium described herein, the prioritization rule indicates which of receiving the downlink communication or transmitting the uplink communication the UE may be to perform based on a channel type, a reference signal type, or both, of the downlink communication or the uplink communication.

In some examples of the method, apparatuses, and non-transitory computer-readable medium described herein, the prioritization rule indicates which of receiving the downlink communication or transmitting the uplink communication the UE may be to perform based on one or more resources associated with the uplink communication, the downlink communication, or both, the one or more resources corresponding to one or more time resources, one or more frequency resources, one or more spatial resource locations, or some combination thereof.

In some examples of the method, apparatuses, and non-transitory computer-readable medium described herein, the prioritization rule indicates which of receiving the downlink communication or transmitting the uplink communication the UE may be to perform based on a first priority associated with an uplink channel for the uplink communication, a second priority associated with a downlink channel for the downlink communication, or both.

In some examples of the method, apparatuses, and non-transitory computer-readable medium described herein, the prioritization rule indicates which of receiving the downlink communication or transmitting the uplink communication the UE may be to perform based on an arrival time of the downlink communication, an arrival time of the uplink communication, or both.

Some examples of the method, apparatuses, and non-transitory computer-readable medium described herein may further include operations, features, means, or instructions for dropping transmission of the uplink communication or deferring transmission of the uplink communication to a future resource based on the prioritization rule.

In some examples of the method, apparatuses, and non-transitory computer-readable medium described herein, the prioritization rule indicates which of receiving the downlink communication or transmitting the uplink communication the UE may be to perform based on a time order of scheduling information for the downlink communication relative to the uplink communication.

In some examples of the method, apparatuses, and non-transitory computer-readable medium described herein, the prioritization rule indicates which of receiving the downlink communication or transmitting the uplink communication the UE may be to perform based on a resource type associated with the symbol period.

In some examples of the method, apparatuses, and non-transitory computer-readable medium described herein, the prioritization rule indicates which of receiving the downlink communication or transmitting the uplink communication the UE may be to perform based on a repetition configuration associated with the uplink communication, the downlink communication, or both.

Some examples of the method, apparatuses, and non-transitory computer-readable medium described herein may further include operations, features, means, or instructions for selecting the prioritization rule from a set of multiple available prioritization rules.

Some examples of the method, apparatuses, and non-transitory computer-readable medium described herein may further include operations, features, means, or instructions for transmitting the uplink communication based least in part on the prioritization rule indicating to transmit a reference signal when the uplink communication may be a reference signal scheduled in the same symbol period as the downlink communication.

Some examples of the method, apparatuses, and non-transitory computer-readable medium described herein may further include operations, features, means, or instructions for refraining from monitoring for at least a portion of the downlink communication based on the prioritization rule, where the at least the portion of the downlink communication overlaps with the uplink communication in a time domain.

In some examples of the method, apparatuses, and non-transitory computer-readable medium described herein, a feedback bit associated with the downlink communication may be transmitted or withheld based on the prioritization rule.

Some examples of the method, apparatuses, and non-transitory computer-readable medium described herein may further include operations, features, means, or instructions for deferring reception of the downlink communication to a future resource based on the prioritization rule.

In some examples of the method, apparatuses, and non-transitory computer-readable medium described herein, the prioritization rule indicates that the uplink communication may be prioritized over the downlink communication or the downlink communication may be prioritized over the uplink communication.

Some examples of the method, apparatuses, and non-transitory computer-readable medium described herein may further include operations, features, means, or instructions for uplink and downlink multiplexing may be enabled during the symbol period based on a restriction on uplink and downlink channel multiplexing being disabled during the symbol period and the restriction on uplink and downlink channel multiplexing may be disabled based on the network entity operating in a full-duplex mode during the symbol period.

A method for wireless communications at a network entity is described. The method may include transmitting, to a UE, first control signaling scheduling a downlink communication during a symbol period, transmitting, to the UE via the first control signaling, second control signaling, or both, an indication of an uplink communication scheduled during the symbol period, transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period, and communicating with the UE during the symbol period via one of the downlink communication or the uplink communication based on the prioritization rule.

An apparatus for wireless communications at a network entity is described. The apparatus may include a processor, memory coupled with the processor, and instructions stored in the memory. The instructions may be executable by the processor to cause the apparatus to transmit, to a UE, first control signaling scheduling a downlink communication during a symbol period, transmit, to the UE via the first control signaling, second control signaling, or both, an indication of an uplink communication scheduled during the symbol period, transmit, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period, and communicate with the UE during the symbol period via one of the downlink communication or the uplink communication based on the prioritization rule.

Another apparatus for wireless communications at a network entity is described. The apparatus may include means for transmitting, to a UE, first control signaling scheduling a downlink communication during a symbol period, means for transmitting, to the UE via the first control signaling, second control signaling, or both, an indication of an uplink communication scheduled during the symbol period, means for transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period, and means for communicating with the UE during the symbol period via one of the downlink communication or the uplink communication based on the prioritization rule.

A non-transitory computer-readable medium storing code for wireless communications at a network entity is described. The code may include instructions executable by a processor to transmit, to a UE, first control signaling scheduling a downlink communication during a symbol period, transmit, to the UE via the first control signaling, second control signaling, or both, an indication of an uplink communication scheduled during the symbol period, transmit, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period, and communicate with the UE during the symbol period via one of the downlink communication or the uplink communication based on the prioritization rule.

In some examples of the method, apparatuses, and non-transitory computer-readable medium described herein, the prioritization rule indicates whether the UE may be to receive the downlink communication or transmit the uplink communication based on a channel type, a reference signal type, or both, of the downlink communication or the uplink communication.

In some examples of the method, apparatuses, and non-transitory computer-readable medium described herein, the prioritization rule indicates whether the UE may be to receive the downlink communication or transmit the uplink communication based on one or more resources associated with the uplink communication, the downlink communication, or both, the one or more resources corresponding to one or more time resources, one or more frequency resources, one or more spatial resource locations, or some combination thereof.

In some examples of the method, apparatuses, and non-transitory computer-readable medium described herein, the prioritization rule indicates whether the UE may be to receive the downlink communication or transmit the uplink communication based on a first priority associated with an uplink channel for the uplink communication, a second priority associated with a downlink channel for the downlink communication, or both.

In some examples of the method, apparatuses, and non-transitory computer-readable medium described herein, the prioritization rule indicates whether the UE may be to receive the downlink communication or transmit the uplink communication based on an arrival time of the downlink communication, an arrival time of the uplink communication, or both.

In some examples of the method, apparatuses, and non-transitory computer-readable medium described herein, the prioritization rule indicates whether the UE may be to receive the downlink communication or transmit the uplink communication based on a resource type associated with the symbol period.

In some examples of the method, apparatuses, and non-transitory computer-readable medium described herein, the prioritization rule indicates whether the UE may be to receive the downlink communication or transmit the uplink communication based on a repetition configuration associated with the uplink communication, the downlink communication, or both.

In some examples of the method, apparatuses, and non-transitory computer-readable medium described herein, the prioritization rule indicates whether the UE may be to receive the downlink communication or transmit the uplink communication based on a time order of scheduling information for the downlink communication and the uplink communication.

In some examples of the method, apparatuses, and non-transitory computer-readable medium described herein, the prioritization rule indicates that the uplink communication may be prioritized over the downlink communication or the downlink communication may be prioritized over the uplink communication.

A method for wireless communications at a UE operating in a full-duplex mode is described. The method may include receiving, from a network entity, a control message scheduling a pair of communications during a symbol period, the pair of communications including an uplink communication scheduled during the symbol period and a downlink communication scheduled during the symbol period, where uplink and downlink channel multiplexing is enabled during the symbol period, monitoring for the downlink communication in the full-duplex mode during the symbol period based on the control message, and transmitting the uplink communication in the full-duplex mode during the symbol period based on the control message.

An apparatus for wireless communications at a UE operating in a full-duplex mode is described. The apparatus may include a processor, memory coupled with the processor, and instructions stored in the memory. The instructions may be executable by the processor to cause the apparatus to receive, from a network entity, a control message scheduling a pair of communications during a symbol period, the pair of communications including an uplink communication scheduled during the symbol period and a downlink communication scheduled during the symbol period, where uplink and downlink channel multiplexing is enabled during the symbol period, monitor for the downlink communication in the full-duplex mode during the symbol period based on the control message, and transmit the uplink communication in the full-duplex mode during the symbol period based on the control message.

Another apparatus for wireless communications at a UE operating in a full-duplex mode is described. The apparatus may include means for receiving, from a network entity, a control message scheduling a pair of communications during a symbol period, the pair of communications including an uplink communication scheduled during the symbol period and a downlink communication scheduled during the symbol period, where uplink and downlink channel multiplexing is enabled during the symbol period, means for monitoring for the downlink communication in the full-duplex mode during the symbol period based on the control message, and means for transmitting the uplink communication in the full-duplex mode during the symbol period based on the control message.

A non-transitory computer-readable medium storing code for wireless communications at a UE operating in a full-duplex mode is described. The code may include instructions executable by a processor to receive, from a network entity, a control message scheduling a pair of communications during a symbol period, the pair of communications including an uplink communication scheduled during the symbol period and a downlink communication scheduled during the symbol period, where uplink and downlink channel multiplexing is enabled during the symbol period, monitor for the downlink communication in the full-duplex mode during the symbol period based on the control message, and transmit the uplink communication in the full-duplex mode during the symbol period based on the control message.

A method for wireless communications at a network entity is described. The method may include transmitting, to a UE operating in a full-duplex mode, a control message scheduling a pair of communications during a symbol period, the pair of communications including an uplink communication scheduled during the symbol period and a downlink communication scheduled during the symbol period, where uplink and downlink channel multiplexing is enabled during the symbol period, transmitting, to the UE, the downlink communication during the symbol period based on the control message, and monitoring for the uplink communication during the symbol period based on the control message.

An apparatus for wireless communications at a network entity is described. The apparatus may include a processor, memory coupled with the processor, and instructions stored in the memory. The instructions may be executable by the processor to cause the apparatus to transmit, to a UE operating in a full-duplex mode, a control message scheduling a pair of communications during a symbol period, the pair of communications including an uplink communication scheduled during the symbol period and a downlink communication scheduled during the symbol period, where uplink and downlink channel multiplexing is enabled during the symbol period, transmit, to the UE, the downlink communication during the symbol period based on the control message, and monitor for the uplink communication during the symbol period based on the control message.

Another apparatus for wireless communications at a network entity is described. The apparatus may include means for transmitting, to a UE operating in a full-duplex mode, a control message scheduling a pair of communications during a symbol period, the pair of communications including an uplink communication scheduled during the symbol period and a downlink communication scheduled during the symbol period, where uplink and downlink channel multiplexing is enabled during the symbol period, means for transmitting, to the UE, the downlink communication during the symbol period based on the control message, and means for monitoring for the uplink communication during the symbol period based on the control message.

A non-transitory computer-readable medium storing code for wireless communications at a network entity is described. The code may include instructions executable by a processor to transmit, to a UE operating in a full-duplex mode, a control message scheduling a pair of communications during a symbol period, the pair of communications including an uplink communication scheduled during the symbol period and a downlink communication scheduled during the symbol period, where uplink and downlink channel multiplexing is enabled during the symbol period, transmit, to the UE, the downlink communication during the symbol period based on the control message, and monitor for the uplink communication during the symbol period based on the control message.

In some examples of the method, apparatuses, and non-transitory computer-readable medium described herein, the uplink communication may be associated with a physical uplink control channel (PUCCH), a physical uplink shared channel (PUSCH), a physical random access channel (PRACH), a sounding reference signal (SRS), an uplink positioning reference signal (PRS), or some combination thereof and the downlink communication may be associated with a synchronization signal block (SSB), a physical downlink control channel (PDCCH), a physical downlink shared channel (PDSCH), a channel state information reference signal (CSI-RS), a downlink PRS, or some combination thereof.

In some examples of the method, apparatuses, and non-transitory computer-readable medium described herein, the pair of communications includes an uplink channel and a downlink channel, one or more reference signals, or some combination thereof.

### BRIEF DESCRIPTION OF THE DRAWINGS

FIG. 1 illustrates an example of a wireless communications system that supports prioritization rules for uplink and downlink channels in full-duplex systems in accordance with one or more aspects of the present disclosure.

FIG. 2 illustrates an example of a wireless communications system that supports prioritization rules for uplink and downlink channels in full-duplex systems in accordance with one or more aspects of the present disclosure.

FIG. 3 illustrates an example of a resource configuration that supports prioritization rules for uplink and downlink channels in full-duplex systems in accordance with one or more aspects of the present disclosure.

FIG. 4 illustrates an example of a resource configuration that supports prioritization rules for uplink and downlink channels in full-duplex systems in accordance with one or more aspects of the present disclosure.

FIGS. 5 and 6 illustrate examples of process flows that supports prioritization rules for uplink and downlink channels in full-duplex systems in accordance with one or more aspects of the present disclosure.

FIGS. 7 and 8 show block diagrams of devices that support prioritization rules for uplink and downlink channels in full-duplex systems in accordance with one or more aspects of the present disclosure.

FIG. 9 shows a block diagram of a communications manager that supports prioritization rules for uplink and downlink channels in full-duplex systems in accordance with one or more aspects of the present disclosure.

FIG. 10 shows a diagram of a system including a device that supports prioritization rules for uplink and downlink channels in full-duplex systems in accordance with one or more aspects of the present disclosure.

FIGS. 11 and 12 show block diagrams of devices that support prioritization rules for uplink and downlink channels in full-duplex systems in accordance with one or more aspects of the present disclosure.

FIG. 13 shows a block diagram of a communications manager that supports prioritization rules for uplink and downlink channels in full-duplex systems in accordance with one or more aspects of the present disclosure.

FIG. 14 shows a diagram of a system including a device that supports prioritization rules for uplink and downlink channels in full-duplex systems in accordance with one or more aspects of the present disclosure.

FIGS. 15 through 20 show flowcharts illustrating methods that support prioritization rules for uplink and downlink channels in full-duplex systems in accordance with one or more aspects of the present disclosure.

### DETAILED DESCRIPTION

In some wireless communications systems, a network entity may communicate with a user equipment (UE), where the network entity and the UE may operate in one or more operational modes, including a half-duplex mode and a full-duplex mode. In the context of a half-duplex mode, a wireless device (e.g., network entity, UE) may be able to perform communications in only one direction at a time (e.g., uplink or downlink, transmit or receive). Comparatively, in the context of a full-duplex mode, a wireless device may be able to simultaneously communicate (e.g., transmit and receive) in multiple directions, such as uplink and downlink. In some cases, a network entity and a UE may operate in different operational modes. For example, a network entity may operate in a full-duplex mode and the UE may operate in a half-duplex mode.

In some cases, a network entity may provision a UE with uplink resources and downlink resources within a given bandwidth part (BWP) to receive downlink communications and transmit uplink communications. For example, a network entity operating in a full-duplex mode may schedule a UE to receive a downlink message (e.g., synchronization signal block (SSB)) and transmit an uplink message (e.g., physical uplink shared channel (PUSCH) message) within a same resource, such as within the same symbol period. However, in cases where the UE is operating in a half-duplex mode, the UE may not expect to be configured or scheduled to perform uplink and downlink messages at the same time. As such, some wireless communications systems may apply a restriction that results in the UE prioritizing (e.g., receiving) the SSB instead of performing the uplink message, even if the SSB transmission is empty. In such cases, the restriction may result in resources not being fully utilized, which may degrade the overall efficiency of the wireless communication system.

Accordingly, aspects of the present disclosure provide prioritization rules used by a UE operating in a half-duplex mode to prioritize a downlink communication or an uplink communication when the uplink communication and the downlink communication are scheduled in a same symbol period and when uplink and downlink channel multiplexing is enabled during the same symbol period. For example, a network entity may operate in a full-duplex mode, and a restriction for multiplexing downlink and uplink channels within a resource (e.g., symbol period) may be relaxed, lifted, or otherwise disabled based on the network entity operating in a full-duplex mode so that a BWP of the resource may be fully utilized (e.g., by the network entity). In other words, the network may enable downlink and uplink channel multiplexing to be performed. In such cases where downlink/uplink channel multiplexing is enabled or allowed (e.g., restriction is lifted or disabled), the network entity may configure or schedule a UE to perform overlapping downlink and uplink communications. In this example, the UE, the network entity, or both, may apply a prioritization rule to determine whether the UE will perform (e.g., prioritize) the downlink communication or the uplink communication.

Techniques described herein may enable UEs to be configured with prioritization rules which enable the UEs and network entities to determine whether the UE is to prioritize downlink or uplink communications in cases where the UE is configured to operate in a half-duplex mode and is configured or scheduled to perform downlink and uplink communications during a same symbol period (e.g., overlapping downlink and uplink communications). Prioritization rules may include various configurations, rules, or conditions used to determine whether downlink or uplink communications are to be prioritized. As such, techniques described herein may resolve ambiguities as to which communications are to be performed when a UE operating in a half-duplex mode is configured or scheduled to perform overlapping uplink and downlink communications. Moreover, techniques described herein may enable the network to enable wireless devices within the network to perform downlink and uplink channel multiplexing, which may enable network entities to operate in a full-duplex mode even in cases where UEs operate in a half-duplex mode. Further, by enabling the network to multiplex downlink and uplink communications within the same time resources (e.g., disable restrictions on downlink/uplink channel multiplexing), techniques described herein may improve resource utilization in the wireless communications system, for example, by enabling BWPs to be fully utilized at network entities for performing overlapping downlink and uplink communications.

In some implementations, prioritization rules may be configured (e.g., pre-configured) at a UE, signaled to the UE from the network, or both. Prioritization rules may resolve scheduling conflicts between overlapping uplink and downlink communications based on any number of parameters, including the channels for the uplink and downlink communications, relative priorities of the downlink and uplink communications, the types of downlink and uplink communications, a relative timing between the downlink and uplink communications, repetition configurations associated with the downlink and uplink communications, and the like. Additionally, aspects of the present disclosure provide techniques for indicating pairs of uplink and downlink signaling that may be simultaneously utilized by a UE operating in a full-duplex mode in concert with the network entity operating in the full-duplex mode.

Aspects of the disclosure are initially described in the context of wireless communications systems. Additional aspects of the disclosure are described in the context of example resource configurations and an example process flow. Aspects of the disclosure are further illustrated by and described with reference to apparatus diagrams, system diagrams, and flowcharts that relate to prioritization rules for uplink and downlink channels in full-duplex systems.

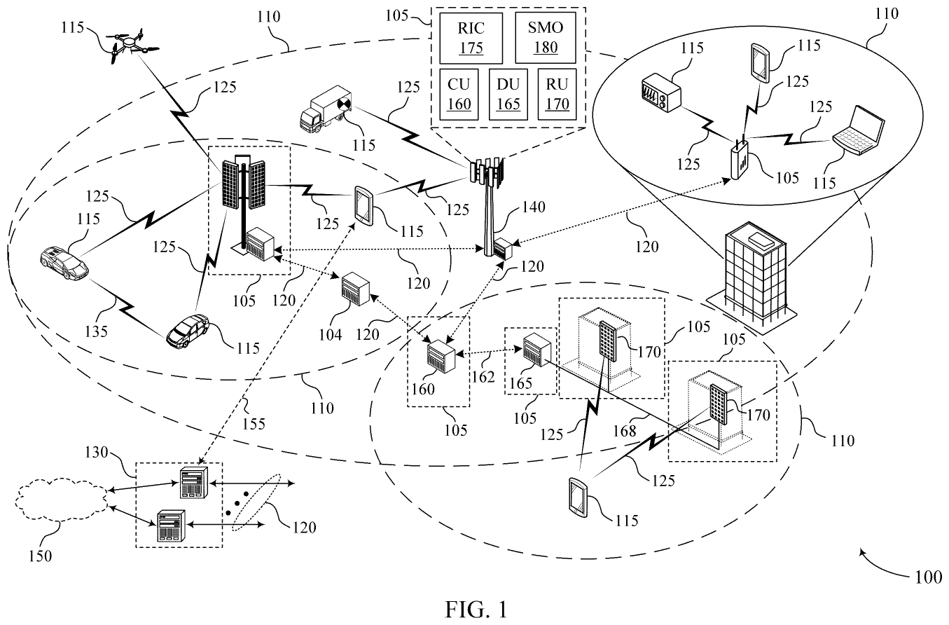

FIG. 1 illustrates an example of a wireless communications system 100 that supports prioritization rules for uplink and downlink channels in full-duplex systems in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be able to communicate with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another over a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 through a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 175 is flexible and may support different functionalities depending upon which functions (e.g., network layer functions, protocol layer functions, baseband functions, RF functions, and any combinations thereof) are performed at a CU 160, a DU 165, or an RU 175. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication over such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 over an interface (e.g., a backhaul link). IAB donor and IAB nodes 104 may communicate over an F1 interface according to a protocol that defines signaling messages (e.g., an F1 AP protocol). Additionally, or alternatively, the CU 160 may communicate with the core network over an interface, which may be an example of a portion of backhaul link, and may communicate with other CUs 160 (e.g., a CU 160 associated with an alternative IAB donor) over an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, and referred to as a child IAB node associated with an IAB donor. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, and may directly signal transmissions to a UE 115. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling over an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support prioritization rules for uplink and downlink channels in full-duplex systems as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) over one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

In some examples, such as in a carrier aggregation configuration, a carrier may also have acquisition signaling or control signaling that coordinates operations for other carriers. A carrier may be associated with a frequency channel (e.g., an evolved universal mobile telecommunication system terrestrial radio access (E-UTRA) absolute RF channel number (EARFCN)) and may be positioned according to a channel raster for discovery by the UEs 115. A carrier may be operated in a standalone mode, in which case initial acquisition and connection may be conducted by the UEs 115 via the carrier, or the carrier may be operated in a non-standalone mode, in which case a connection is anchored using a different carrier (e.g., of the same or a different radio access technology).

The communication links 125 shown in the wireless communications system 100 may include downlink transmissions (e.g., forward link transmissions) from a network entity 105 to a UE 115, uplink transmissions (e.g., return link transmissions) from a UE 115 to a network entity 105, or both, among other configurations of transmissions. Carriers may carry downlink or uplink communications (e.g., in an FDD mode) or may be configured to carry downlink and uplink communications (e.g., in a TDD mode).

A carrier may be associated with a particular bandwidth of the RF spectrum and, in some examples, the carrier bandwidth may be referred to as a “system bandwidth” of the carrier or the wireless communications system 100. For example, the carrier bandwidth may be one of a set of bandwidths for carriers of a particular radio access technology (e.g., 1.4, 3, 5, 10, 15, 20, 40, or 80 megahertz (MHz)). Devices of the wireless communications system 100 (e.g., the network entities 105, the UEs 115, or both) may have hardware configurations that support communications over a particular carrier bandwidth or may be configurable to support communications over one of a set of carrier bandwidths. In some examples, the wireless communications system 100 may include network entities 105 or UEs 115 that support concurrent communications via carriers associated with multiple carrier bandwidths. In some examples, each served UE 115 may be configured for operating over portions (e.g., a sub-band, a BWP) or all of a carrier bandwidth.

Signal waveforms transmitted over a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both) such that the more resource elements that a device receives and the higher the order of the modulation scheme, the higher the data rate may be for the device. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, where a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, where Δfₘₐₓ may represent the maximum supported subcarrier spacing, and N_{f} may represent the maximum supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots containing one or more symbols. Excluding the cyclic prefix, each symbol period may contain one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed on a carrier according to various techniques. A physical control channel and a physical data channel may be multiplexed on a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be able to communicate directly with other UEs 115 over a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by or scheduled by the network entity 105. In some examples, one or more UEs 115 in such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without the involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. The UHF waves may be blocked or redirected by buildings and environmental features, which may be referred to as clusters, but the waves may penetrate structures sufficiently for a macro cell to provide service to the UEs 115 located indoors. The transmission of UHF waves may be associated with smaller antennas and shorter ranges (e.g., less than 100 kilometers) compared to transmission using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology in an unlicensed band such as the 5 GHz industrial, scientific, and medical (ISM) band. While operating in unlicensed RF spectrum bands, devices such as the network entities 105 and the UEs 115 may employ carrier sensing for collision detection and avoidance. In some examples, operations in unlicensed bands may be based on a carrier aggregation configuration in conjunction with component carriers operating in a licensed band (e.g., LAA). Operations in unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located in diverse geographic locations. A network entity 105 may have an antenna array with a set of rows and columns of antenna ports that the network entity 105 may use to support beamforming of communications with a UE 115. Likewise, a UE 115 may have one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase the spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), where multiple spatial layers are transmitted to the same receiving device, and multiple-user MIMO (MU-MIMO), where multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating at particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate over logical channels. A MAC layer may perform priority handling and multiplexing of logical channels into transport channels. The MAC layer may also use error detection techniques, error correction techniques, or both to support retransmissions at the MAC layer to improve link efficiency. In the control plane, the RRC protocol layer may provide establishment, configuration, and maintenance of an RRC connection between a UE 115 and a network entity 105 or a core network 130 supporting radio bearers for user plane data. At the PHY layer, transport channels may be mapped to physical channels.

The UEs 115 and the network entities 105 may support retransmissions of data to increase the likelihood that data is received successfully. Hybrid automatic repeat request (HARQ) feedback is one technique for increasing the likelihood that data is received correctly over a communication link (e.g., a communication link 125, a D2D communication link 135). HARQ may include a combination of error detection (e.g., using a cyclic redundancy check (CRC)), forward error correction (FEC), and retransmission (e.g., automatic repeat request (ARQ)). HARQ may improve throughput at the MAC layer in poor radio conditions (e.g., low signal-to-noise conditions). In some examples, a device may support same-slot HARQ feedback, where the device may provide HARQ feedback in a specific slot for data received in a previous symbol in the slot. In some other examples, the device may provide HARQ feedback in a subsequent slot, or according to some other time interval.

The network entities 105, UEs 115, and other wireless devices of the wireless communications system 100 may be configured to support prioritization rules used to determine whether a UE 115 operating in a half-duplex mode is to prioritize downlink or uplink communications when the UE 115 is configured or scheduled with overlapping downlink and uplink communications. In particular, the wireless communications system 100 may support prioritization rules including configurations and conditions which are used to resolve conflicts between overlapping downlink and uplink communications, and to determine whether a UE 115 is to prioritize (e.g., perform) a downlink or uplink communication in cases where the scheduled downlink and uplink communications overlap in time.

For example, a network entity 105 of the wireless communications system 100 may operate in a full-duplex mode, and a restriction for multiplexing downlink and uplink channels within a resource (e.g., symbol period) may be relaxed or lifted based on the network entity 105 operating in a full-duplex mode. In other words, a restriction may be lifted such that the network entity 105 can configure/schedule overlapping downlink and uplink communications so that a BWP of a given time resource be fully utilized by the network entity 105 (e.g., restriction lifted to enable the network entity 105 to perform full-duplex communications and perform downlink/uplink channel multiplexing). In such cases where downlink/uplink channel multiplexing is enabled (e.g., restriction is lifted or disabled), the network entity 105 may configure or schedule a UE 115 to perform overlapping downlink and uplink communications. In this example, the UE 115, the network entity 105, or both, may apply a prioritization rule to determine whether the UE 115 will perform (e.g., prioritize) the downlink communication or the uplink communication. Subsequently, the UE 115 may perform one of the downlink communication or the uplink communication in accordance with the prioritization rule.

In some implementations, prioritization rules may be configured (e.g., pre-configured) at the UE 115, signaled to the UE 115 from the network, or both. Prioritization rules may resolve scheduling conflicts between overlapping uplink and downlink communications based on any number of parameters, including the channels for the uplink and downlink communications, the types of downlink and uplink communications, a relative timing between the downlink and uplink communications, and the like. Additionally, aspects of the present disclosure provide techniques for indicating pairs of uplink and downlink signaling that may be simultaneously utilized by the UE 115 operating in a full-duplex mode in concert with the network entity operating in the full-duplex mode.

Techniques described herein may enable a UE 115 to be configured with prioritization rules which enable the UE 115 and network entity 105 to determine whether the UE 115 is to prioritize downlink or uplink communications in cases where the UE 115 is configured or scheduled to perform overlapping downlink and uplink communications. As such, techniques described herein may resolve ambiguities as to which communications are to be performed when the UE 115 operating in a half-duplex mode is configured or scheduled to perform overlapping uplink and downlink communications. Moreover, techniques described herein may enable the network to perform downlink and uplink channel multiplexing within the same time resources, which may enable network entities 105 to operate in a full-duplex mode even in cases where UEs 115 operate in a half-duplex mode. Further, by enabling the network to perform downlink and uplink channel multiplexing (e.g., lift restrictions which prevent downlink/uplink channel multiplexing), techniques described herein may improve resource utilization in the wireless communications system 100, for example, by enabling BWPs to be fully utilized at network entities 105 for performing overlapping downlink and uplink communications.

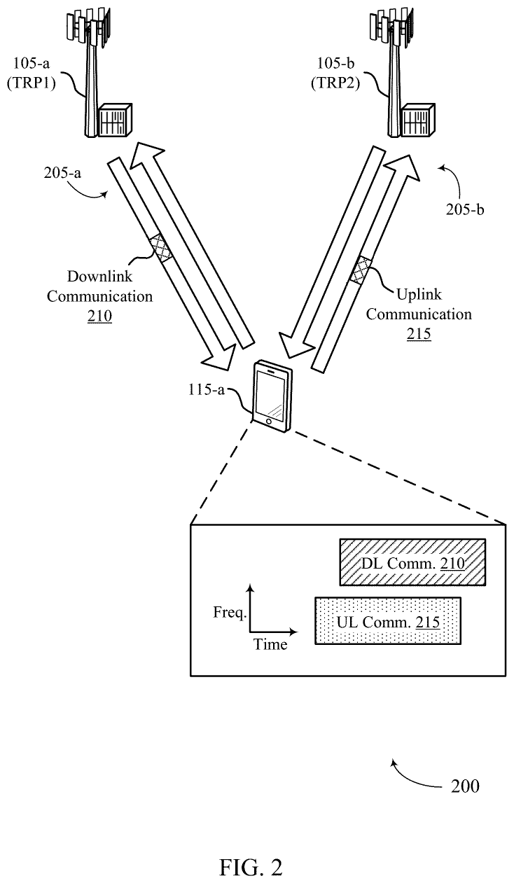

FIG. 2 illustrates an example of a wireless communications system 200 that supports prioritization rules for uplink and downlink channels in full-duplex systems in accordance with one or more aspects of the present disclosure. In some examples, aspects of the wireless communications system 200 may implement, or be implemented by, aspects of the wireless communications system 100.

The wireless communications system 200 may include a first network entity 105-a, a second network entity 105-b, and a UE 115-a, which may be examples of network entities 105 and UEs 115 as described with reference to FIG. 1. The UE 115-a may communicate with the network entities 105-a, 105-b (e.g., communicate with the respective TRPs) using communication links 205-a and 205-b, respectively, which may be examples of NR or LTE links between the UE 115-a and the respective TRPs/network entities 105-a, 105-b. In some cases, the communication links 205-a, 205-b between the UE 115-a and the network entities 105-a, 105-b may include examples of access links (e.g., Uu links) which may include bi-directional links that enable both uplink and downlink communication. For example, the UE 115-a may transmit uplink signals, such as uplink control signals or uplink data signals, to one or more components of the first network entity 105-a using the communication link 205-a, and one or more components of the first network entity 105-a may transmit downlink signals, such as downlink control signals or downlink data signals, to the UE 115-a using the communication link 205-a.

Additionally, or alternatively, the first network entity 105-a and the second network entity 105-b may be examples of first and second transmission-reception points (TRPs) associated with one or more network entities 105. For example, in some cases, the UE 115-a may communicate with a first TRP (e.g., TRP1) via the communication link 205-a, and may communicate with a second TRP (e.g., TRP2) via the communication link 205-b. In such cases, the first and second TRPs (e.g., TRP1, TRP2) may be associated with the same or different network entities 105.

As noted previously herein, some wireless communications systems enable network entities 105 and other devices to perform both half-duplex and full-duplex communications (e.g., half-duplex and full-duplex operational modes). In the context of a half-duplex mode, a wireless device (e.g., network entity 105-a, 105-b, UE 115) may be configured to transmit or receive in only one direction at a time. Comparatively, in the context of a full-duplex mode, a wireless devices may be able to simultaneously perform downlink and uplink communications. For example, the network entity 105-a of the wireless communications system 200 may support a full-duplex mode in which the network entity 105-a is able to simultaneously transmit downlink communications and receive uplink communications in a set of resources (e.g., Frequency Range 1 (FR1), Frequency Range 2 (FR2), etc.).

Full-duplex communications may provide a number of advantages. For example, full-duplex communications may enable wireless devices to simultaneously perform uplink and downlink communications (e.g., receive downlink signals in uplink-only slots), thereby resulting in a latency reduction. Moreover, full-duplex communications may result in a spectrum efficiency enhancement (e.g., per cell, per UE 115), and result in more efficient resource utilization and coverage enhancement. However, full-duplex capabilities may be conditional on a number of parameters, including beam separation, self-interference between uplink and downlink, and clutter echo. As such, when implementing full-duplex communications, respective components of the wireless communications system 200 may be configured to exchange coordinated parameters, including power control parameters, beam information, and Tx/Rx timing.

The respective wireless devices (e.g., first network entity 105-a, second network entity 105-b, UE 115-a) of the wireless communications system 200 may be configured to support half-duplex modes, full-duplex modes, or both. For example, in cases where the first network entity 105-a supports full-duplex communications (e.g., supports a full-duplex mode), the first network entity 105-a may be configured to transmit uplink communications via a first antenna panel, and simultaneously receive downlink communications via a second antenna panel. By way of another example, in cases where the UE 115-a supports full-duplex communications, the first UE 115-a may be configured to transmit uplink communications to the first network entity 105-a via a first antenna panel, and simultaneously receive downlink communications from the second network entity 105-b via a second antenna panel. Further, during a full-duplex operational mode at the first UE 115-a, the first UE 115-a may be configured to transmit uplink signals to a first TRP (e.g., TRP1), and simultaneously receive downlink signals from a second TRP (e.g., TRP2).

The operational modes implemented by the respective wireless devices may be implemented independently from one another. For example, in some cases, the first network entity 105-a, the second network entity 105-b, or both, may operate in full-duplex modes while the UE 115-a operates in a half-duplex mode. In such cases, the network entity 105-a may exhibit enhanced duplexing capability, and support single-frequency full-duplex (SFFD) and FDM/spatial division multiplexing (SDM) with resource block group (RBG) granularity.

Some wireless communications systems implement “restrictions” which restrict the ability of the network to configure or schedule uplink and downlink communications which overlap in time. That is, some wireless communications systems implement a restriction which prevents multiplexing overlapping uplink and downlink communications (e.g., downlink/uplink channel multiplexing restriction). Such a restriction may prevent the network from configuring/scheduling UEs 115 operating in a half-duplex mode with overlapping uplink and downlink communications. In other words, such restrictions may prevent the network from scheduling full-duplex communications at UEs 115 which are not or are unable to operate in a full-duplex mode, even in cases where a network entity 105 is otherwise able to operate in a full-duplex mode.

However, such multiplexing restrictions which prevent multiplexing overlapping uplink and downlink communications may detrimentally affect signaling overhead if a bandwidth is not fully utilized by a respective downlink communication (e.g., SSB) or uplink communication (e.g., random access channel (RACH) occasion (RO)). For example, a UE 115 may be configured with multiple RO resources for transmitting RACH messages, where each RO resource spans 384 symbols in the time domain and 17 MHz in the frequency domain. Each RO period (e.g., 10 ms, 1120 symbols) may include 64 RO resources. Moreover, each RO resource may span a portion of a carrier aggregation bandwidth spanning X MHz. As such, in theory, a portion of the bandwidth which is not allocated to the RO resource may be used for other communications, such as downlink communications.

However, in cases where the network implements a restriction which prevents multiplexing downlink and uplink communications, the portion of the bandwidth which is not allocated to the RO resource may be wasted (e.g., unable to be used for downlink communications). Moreover, the percentage or proportion of the bandwidth which is wasted as a result of the multiplexing restriction may be dependent on the size of the bandwidth (X MHz), as illustrated in Table 1 below:

TABLE 1
Percentage of Wasted Resources as
a Function of Bandwidth

| Carrier | Percentage of Resources |
|---|---|
| Aggregation BW | Unavailable to Downlink |
| X = 100 MHz | Y = 29% |
| X = 400 MHz | Y = 33% |
| X = 800 MHz | Y = 34% |

Table 1 above illustrates the percentage of wasted resources within a given bandwidth as a function of a size of the bandwidth in cases where the network implements a restriction on downlink/uplink resources. In particular, Table 1 assumes FR2 with an SCS of 120 kHz, a preamble format B3 (which is typical for FR2), total operation of bandwidth with size X MHz, a RO period of 10 ms with 64 RO resources in time per RO period, and no FDMed RO resources (e.g., single RO resource per symbol). As may be seen in Table 1 above, the larger the size of the bandwidth (e.g., the larger the value of X), the larger percentage of resources which are wasted (e.g., unavailable for downlink communications) as a result of the downlink/uplink restriction.

In this regard, restrictions on downlink/uplink multiplexing may lead to an inefficient use of resources (e.g., more wasted/unused resources). Moreover, in cases where network entities 105 and other wireless devices (e.g., UEs 115) are able to perform full-duplex communications, such restrictions may effectively prevent the wireless devices from performing full-duplex communications, thereby preventing the attendant advantages associated with full-duplex communications (e.g., reduced latency, more efficient use of resources).

As such, some wireless communications systems may enable the network to relax or lift such restrictions to enable the network to schedule overlapping uplink and downlink messages. That is, some wireless communications systems may enable a network entity 105 to configure or schedule overlapping uplink and downlink communications such that the configured/scheduled uplink and downlink communications may be multiplexed in the same time resources. For example, in cases where the first network entity 105-a operates in a full-duplex mode, a restriction which prevents multiplexing downlink and uplink communications may be lifted or relaxed such that the network entity 105-a may schedule overlapping uplink and downlink communications at the UE 115-a. However, lifting such downlink/uplink multiplexing restrictions may result in issues in cases where the network entities 105-a, 105-b operate in a full-duplex mode, but where the UE 115-b operates in a half-duplex mode.

For example, a restriction that prevents uplink/downlink multiplexing may be lifted based on the first network entity 105-a and/or the second network entity 105-b operating in a full-duplex mode. In this example, and due to the lifted restriction, the UE 115-a may be scheduled to perform an downlink communication 210 and an uplink communication 215 which at least partially overlap in time. For instance, the downlink communication 210 and the uplink communication 215 may be scheduled in the same time resource (e.g., same symbol period). However, in cases where the UE 115-a is operating in a half-duplex mode, the UE 115-a may not expect to be configured or scheduled to perform uplink and downlink communications at the same time. Moreover, the UE 115-b may be unable to perform both the downlink communication 210 and the overlapping uplink communication 215 due to the UE 115-a operating in the half-duplex mode, and it may be unclear whether the UE 115-a is to perform the downlink communication 210 or the uplink communication 215.

Accordingly, aspects of the present disclosure provide prioritization rules used to determine whether the UE 115-a operating in a half-duplex mode is to prioritize downlink or uplink communications when the UE 115-a is configured or scheduled with overlapping downlink and uplink communications. In particular, aspects of the present disclosure provide prioritization rules which may be used to determine whether the UE 115-a is to prioritize (e.g., perform) the downlink communication 210 or the overlapping uplink communication 215. As such, techniques described herein may enable network entities 105 to expect whether the UE 115-a will prioritize (e.g., perform) the downlink communication 210 or the uplink communication 215. Prioritization rules may include various configurations, rules, or conditions used to determine whether downlink or uplink communications are to be prioritized. As such, techniques described herein may resolve ambiguities as to which communications are to be performed when the UE 115-a operating in a half-duplex mode is configured or scheduled to perform overlapping uplink and downlink communications.

For example, as shown in FIG. 2, the UE 115-a may be scheduled to receive a downlink communication 210 and transmit an uplink communication 215, where the downlink communication 210 and the uplink communication at least partially overlap in the time domain. For example, the downlink communication 210 and the uplink communication 215 may be scheduled within the same symbol period (e.g., within RRC-flexible symbols). The downlink communication 210 may include a PDCCH message, a PDSCH message (e.g., semi-persistent PDSCH, aperiodic PDSCH), an SPS message, an SSB message, a CSI-RS (e.g., periodic, semi-persistent, or aperiodic CSI-RS for channel state information (CSI)), a tracking reference signal (TRS), a broadcast message (BM) or any combination thereof. Moreover, the uplink communication 215 may include a PUCCH message (e.g., periodic, semi-persistent, or aperiodic PUCCH message), a PUSCH message (e.g., periodic, semi-persistent, or aperiodic PDSCH), a physical random access channel (PRACH) message, an SRS (e.g., periodic, semi-persistent, or aperiodic SRS), a scheduling request, and the like. In some aspects, the UE 115-a may be scheduled to perform the downlink communication 210 and the uplink communication 215 via one or more control messages (e.g., RRC message, DCI message, MAC-CE) received from the first network entity 105-a, the second network entity 105-b, or both.

As noted previously herein, some wireless communications systems may implement a restriction which prevents downlink and uplink channel multiplexing within the same time resources (e.g., within the same symbol period). Such restrictions may prevent the UE 115-a from being scheduled to perform downlink communication 210 and the uplink communication 215 in the same symbol period. As such, in some cases, network of the wireless communications system 200 may relax, lift, or otherwise disable such downlink/uplink multiplexing restrictions to enable the network entities 105-a, 105-b to schedule the downlink communication 210 and the uplink communication 215 in the same symbol period. In some cases, a downlink/uplink multiplexing restriction may be disabled or relaxed in cases where the first network entity 105-a and/or the second network entity 105-a operates in a full-duplex mode. In this regard, in some implementations, the UE 115-a may be scheduled to perform the downlink communication 210 and the uplink communication 215 in the same symbol period based on downlink and uplink channel multiplexing being enabled for at least the symbol period (e.g., based on the network entities 105-a, 105-b operating in the full-duplex mode).

In cases where the UE 115-a is configured to operate in a half-duplex mode during the symbol period in which the downlink communication 210 and the uplink communication 215 are scheduled, the UE 115-a may be unable to perform both communications. That is, the UE 115-a may not be expected to perform the overlapping downlink communication 210 and the uplink communication 215. As such, in some aspects, the UE 115-a, the network entities 105-a, 105-b, or both, may be configured to utilize one or more prioritization rules that are used to determine whether the UE 115-a will perform (e.g., is expected to perform) the downlink communication 210 or the uplink communication 215. Prioritization rules may be associated with the half-duplex mode at the UE 115-a, and may include rules, configurations, or conditions which indicate whether the UE 115-a is to perform downlink or uplink messages in cases where the UE 115-a is scheduled to perform downlink and uplink messages in the same symbol period, and in cases where uplink and downlink channel multiplexing is enabled.

In other words, the UE 115-a may be configured with one or more prioritization rules for downlink/uplink channels and reference signals on the same symbol. In other words, the respective wireless devices may use or apply one or more prioritization rules to determine whether the UE 115-a will perform the downlink communication 210 or the uplink communication 215. That is, prioritization rules may be used to select which one of the downlink communication 210 or the uplink communication 215 will be performed by the UE 115-a.

Prioritization rules may be configured (e.g., pre-configured) at the UE 115-a, signaled to the UE 115-a, or both. For example, in some cases, the UE 115-a may receive control signaling indicating one or more candidate (e.g., available) prioritization rules usable for resolving conflicts between overlapping downlink and uplink communications. In additional or alternative implementations, the UE 115-a may be configured (e.g., programmed, fabricated) with prioritization rules without any explicit signaling from the network.

In some aspects, prioritization rules may include configurations, rules, or conditions which enable the UE 115-a and the network entities 105-a, 105-b to determine which of the downlink communication 210 or the uplink communication 215 the UE 115-a is to perform. In some cases, prioritization rules may expressly indicate which signals are prioritized over others (e.g., Signal A is always prioritized over signal B, or vice versa). In other cases, prioritization rules may indicate conditions or thresholds which, if satisfied, result in certain signals being prioritized over others (e.g., implicit rules). For example, a prioritization rule may indicate that Signal A is prioritized over Signal B if Condition #1 is true; Signal B is prioritized over Signal A if Condition #2 is true. In this example, Condition #1 may be the opposite of Condition #2. For example, Signal A can be any set of the following DL channels or reference signals: PDCCH; semi-persistent PDSCH; aperiodic PDSCH; SSB; periodic, semi-persistent, or aperiodic for CSI, beam management (BM), and tracking reference signals (TRS). Signal B can be any set of the following UL channel or reference signals:
periodic, semi-persistent, or aperiodic PUCCH; periodic, semi-persistent, or aperiodic PUSCH; PRACH; periodic, semi-persistent, or aperiodic SRS for BM, CB, NCB, and AS.

In cases where the UE 115-a is configured with multiple candidate/available prioritization rules, the UE 115-a, the network entities 105-a, 105-b, or both, may determine or select which prioritization rule is to be applied. The process of determining/selecting which prioritization rule will be applied may be referred to as the “prioritization decision.” For example, the first network entity 105-a may configure the UE 115-a with a set of candidate prioritization rules, and may subsequently indicate which prioritization rule is to be applied. In this example, the prioritization rule that is to be applied (e.g., prioritization decision) is indicated via explicit signaling (e.g., first network entity 105-a indicates the prioritization rule via RRC, MAC-CE, or DCI).

In additional or alternative implementations, which prioritization rule is to be used may be left up to UE 115-a implementation. That is, the UE 115-a may select a prioritization rule from a set of candidate/available prioritization rules which will be used to resolve the conflict between the downlink communication 210 and the uplink communication 215. In such cases, the UE 115-a may indicate to the network entities 105-a, 105-b which prioritization rule is selected, or the network entities 105-a, 105-b may determine which prioritization rule was selected (e.g., whether the UE 115-a prioritized the downlink communication 210 or the uplink communication 215) based on feedback or subsequent communications received from the UE 115-a (e.g., if the UE 115-a transmits an ACK for the downlink communication 210, the network entities 105-a, 105-b may determine that that the UE 115-a applied a prioritization rule which prioritized the downlink communication 210 over the uplink communication 215).

Stated differently, a network entity 105 operating in a full-duplex mode may include a downlink antenna panel for transmitting downlink communications and an uplink antenna panel for receiving uplink communications. As such, the network entity 105 may prepare for both transmitting downlink and receiving uplink communications simultaneously, even though only one of the downlink or uplink communications will be prioritized/performed based on the prioritization rule implemented by the UE 115-a. As such, prioritization rules described herein may enable the network entity 105 to expect, assume, or determine whether either downlink or uplink communications are to be prioritized based on different options (e.g., which prioritization rule is applied). For example, in cases where the network entity 105 receives feedback (e.g., ACK) responsive to the downlink message 210, the network entity 105 may determine that the downlink communication 210 was prioritized. Conversely, if the network entity 105 receives the uplink communication 215, the network entity 105 may determine that the uplink communication 215 was prioritized.

Prioritization rules may be used to determine relative priorities between overlapping downlink and uplink communications in order to resolve scheduling conflicts between such communications. Prioritization rules may determine or indicate relative priorities between downlink and uplink communications (e.g., downlink communication 210, uplink communication 215) based on any number of parameters, including the channels for the downlink and uplink communications, relative priorities of the downlink and uplink communications, the types of downlink and uplink communications, a relative timing between the downlink and uplink communications, repetition configurations associated with the downlink and uplink communications, and the like.

For example, in some cases, the UE 115-a may be scheduled to transmit a scheduling request (uplink communication 215) and receive an SPS (downlink communication 210) on the same symbol period (e.g., same RRC flexible symbol) in cases where downlink and uplink channel multiplexing is enabled on the symbol period (in cases where a restriction on downlink/uplink channel multiplexing is relaxed). For example, the UE 115-a may be scheduled with periodic scheduling request PUCCH occasions. In this example, the UE 115-a may apply a prioritization rule which prioritizes the SPS (downlink communication 210) if no scheduling request (uplink communication 215) is transmitted by the UE 115-a on the PUCCH-SR occasion (e.g., SR for beam failure recovery), otherwise the prioritization rule prioritizes the scheduling request (uplink communication 215) over the SPS (downlink communication 210), in which case the SPS is ignored or dropped. In other words, the prioritization rule may cause the UE 115-a to prioritize the scheduling request, but may prioritize the SPS if the UE 115-a does not have any scheduling requests to transmit.

In some cases, prioritization rules may be used to determine or indicate relative priorities between communications based on channel or reference signal properties associated with the downlink communication 210, the uplink communication 215, or both (e.g., channel type, reference signal type). The types of communications may be based on direction (e.g., downlink signals prioritized over uplink signals, or vice versa), time-domain behavior (e.g., aperiodic signals are prioritized over semi-persistent signals, or vice versa), channel/reference signal type (e.g., CSI-RS is prioritized over PUSCH, or vice versa; ACK is prioritized over CSI-RS, or vice versa), or any combination thereof.

In additional or alternative implementations, prioritization rules may be used to determine or indicate relative priorities between communications based on time/frequency/spatial resources associated with the downlink communication 210, the uplink communication 215, or both. For example, a prioritization rule may indicate that signals with earlier starting/ending symbols are prioritized over signals with later starting/ending symbols. By way of another example, a prioritization rule may indicate that the signal on a component carrier with the highest or lowest component carrier index is prioritized, or that a signal on a primary component carrier (PCC) is prioritized over a signal on a secondary component carrier (SCC). By way of another example, a prioritization rule may indicate that a signal scheduled on Beam #1 (e.g., downlink beam indicated by SSB #5 with better quality) is to be prioritized over a signal scheduled on Beam #2 (e.g., uplink beam indicated by SSB #10 with worse quality).

In additional or alternative implementations, prioritization rules may be used to determine or indicate relative priorities between communications based on channel or reference signal priorities or content associated with the downlink communication 210, the uplink communication 215, or both (e.g., channel priority/content, reference signal priority/content). For example, a prioritization rule may indicate that a signal with a higher quality of service (QoS) requirement (e.g., shorter delay budget, lower packet error rate (PER) requirement, etc.) is prioritized over a signal with a lower QoS requirement. By way of another example, a prioritization rule may indicate that the signal with the higher priority at a particular layer (e.g., Layer one (L1), Layer two (L2), Layer 3 (L3) is prioritized (e.g., based on logic channel priority rule, PHY layer priority, etc.).

By way of another example, a prioritization rule may indicate that control signals are prioritized over data signals. For instance, a prioritization rule may indicate that the uplink communication 215 providing relay service is prioritized over the eMBB downlink communication 210. Moreover, a prioritization rule may indicate that the downlink communication 210 associated with L1/L2 mobility cell/beam switching is to be prioritized over the regular uplink communication 215 including a control signal (e.g., uplink ACK, UCI).

In additional or alternative implementations, prioritization rules may determine or indicate relative priorities between downlink signals (e.g., downlink communication 210) and uplink signals (e.g., uplink communication 215) based on traffic arrival times of the respective signals (e.g., Signal A is prioritized if Signal B has no arrived traffic, otherwise Signal B is prioritized), and/or based on a relative time order of scheduling information associated with the respective signals (e.g., relative order in which the signals are scheduled). For example, in cases where PDSCH (e.g., downlink communication 210) and PUSCH (e.g., uplink communication 215) are scheduled to overlap on the same symbol, a prioritization rule may prioritize the signal/channel which is scheduled by a DCI that arrives at the UE 115-a earlier or later in time.

In additional or alternative implementations, prioritization rules may determine or indicate relative priorities between downlink signals (e.g., downlink communication 210) and uplink signals (e.g., uplink communication 215) based on resource types of overlapping downlink and uplink signals (e.g., PDSCH or PUSCH is prioritized if the symbol period on which the communications are scheduled includes an RRC-downlink or RRC-uplink symbol), or based on a repetition configuration associated with the respective signals (e.g., downlink communication 210 or uplink communication 215 associated with repetitions is prioritized, and the one with more repetitions is prioritized if both communications are associated with repetitions). For instance, if the downlink communication 210 includes one of five repetitions of the same message, and the uplink communication 215 includes one of ten repetitions of the same message, a prioritization rule may cause the UE 115-a to prioritize the uplink communication 215.

In some cases, a prioritization rule applied by the UE 115-a and/or network entities 105-a, 105-b may result in the downlink communication 210 and the uplink communication 215 being associated with the same priority. In other words, there may be cases in which a prioritization rule fails to resolve the conflict between the downlink communication 210 and the uplink communication 215. In such cases, multiple prioritization rules and/or multiple criterion for a single prioritization rule may be used to resolve the conflict. For example, if a first criterion of a prioritization rule results in the downlink communication 210 and the uplink communication 215 ending up with the same priority, a second criterion may be further introduced with the prioritization rule to determine which of the downlink communication 210 or the uplink communication 215 should be prioritized.

Downlink and uplink multiplexing rules or restrictions may be applied (e.g., enabled, disabled) for downlink and uplink communications on the same component carrier, on different component carriers, in the same/different bands for carrier aggregation or dual connectivity, or any combination thereof. Similarly, prioritization rules may be applied for downlink and uplink communications on the same component carrier, on different component carriers, in the same/different bands for carrier aggregation or dual connectivity, or any combination thereof.

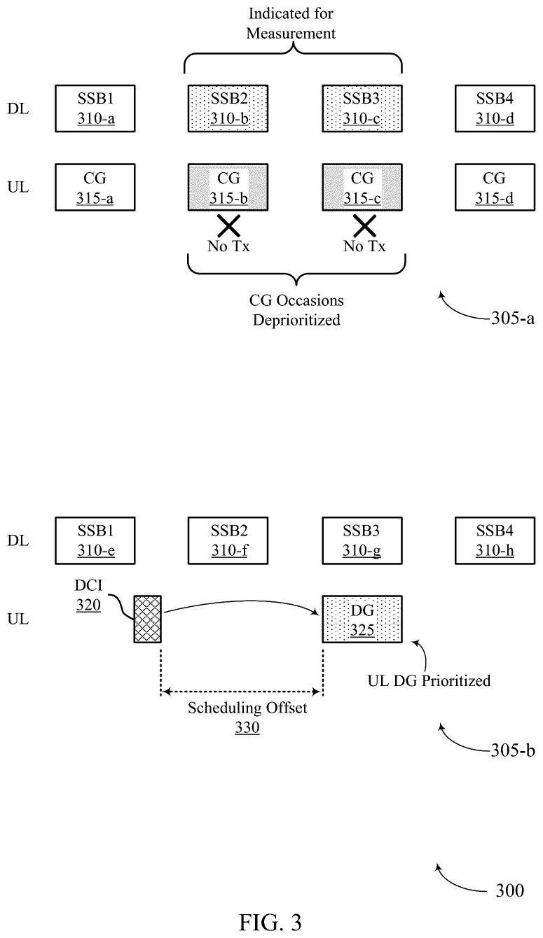

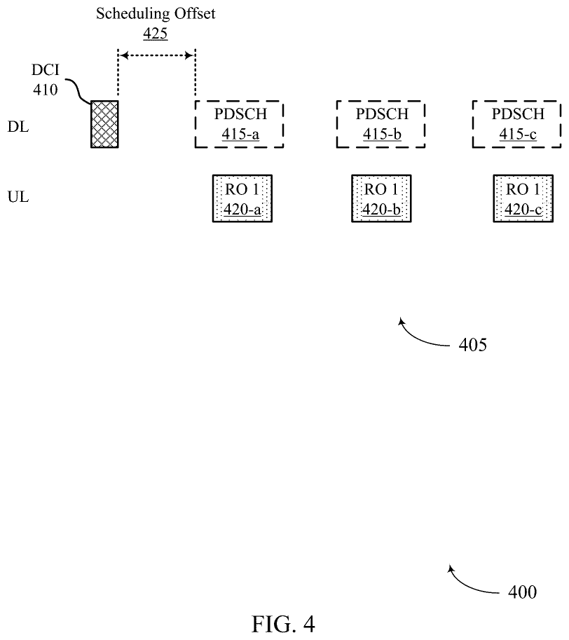

Additional examples of prioritization rules that may be used to determine or indicate relative priorities between downlink and uplink communications will be further shown and described with reference to FIGS. 3 and 4.

Upon identifying/selecting a prioritization rule, the UE 115-a, the first network entity 105-a, the second network entity 105-b, or any combination thereof, may apply the prioritization rule to determine which of the downlink communication 210 or uplink communication 215 is to be prioritized, and therefore performed by the UE 115-b.

In some aspects, there are several actions or rules the UE 115-a may apply for the deprioritized signal (e.g., signal with lower priority based on the prioritization rule). Actions for the deprioritized signal may include, but are not limited to, the UE 115-a dropping the deprioritized signal, performing a subset of the deprioritized signal, deferring the deprioritized signal to an available future resource, or any combination thereof.

For example, in some cases, the UE 115-a may perform the downlink communication 210 based on determining that the downlink signal has a higher priority according to a prioritization rule. In this example, the first UE 115-a may drop (e.g., not transmit or refrain from performing) the deprioritized uplink communication 215. Conversely, if the uplink communication 215 is prioritized, the UE 115-a may drop (e.g., refrain from receiving, refrain from monitoring for, or ignore) the deprioritized downlink communication 210. In some cases, the UE 115-a may be configured to drop only a portion of the deprioritized signal, such as a portion of the deprioritized signal which overlaps in the time domain with the prioritized signal. In some cases, whether the UE 115-a completely or only partially drops the deprioritized signal may be based on the channel type(s) and/or reference signal type(s) associated with the respective downlink communication 210 and the uplink communication 215. For example, the UE 115-a may be configured to completely drop (e.g., refrain from transmitting/receiving, refrain from monitoring) PUCCH messages, PUSCH messages, PDCCH messages, and PDSCH messages, but may be configured to only partially drop (e.g., perform a portion of) CSI-RSs and SRSs.

In cases where the UE 115-a completely or partially drops (e.g., refrains from receiving/monitoring for) the downlink communication 210, such as PDSCH messages or CSI-RSs, there are several implementations for handling feedback (e.g., ACK/NACK) associated with the dropped downlink communication 210. In accordance with a first implementation, upon completely or partially dropping the downlink communication 210, the UE 115-a may refrain from transmitting any feedback bits (e.g., no ACK/NACK bit is transmitted). Comparatively, in accordance with a second implementation, upon completely or partially dropping the downlink communication 210, the UE 115-a may transmit a NACK bit. In some cases, whether the UE 115-a utilizes the first or second implementation may depend on a HARQ-ACK codebook type. For example, the UE 115-a may utilize the first implementation (e.g., no ACK/NACK bit transmitted) for Type 1 codebook communications, and may utilize the second implementation (e.g., NACK bit transmitted) for Type 2 codebook communications. Moreover, such implementations associated with feedback for dropped downlink communications 210 may be applied for PDSCH messages, as well as other types of downlink signals, such as for providing CSI reports (uplink) in response to dropped CSI-RSs.

In additional or alternative implementations, the UE 115-a may defer the deprioritized signal to a future available resource. The future available resource may be configured (e.g., pre-configured) by the network entities 105-a, 105-b, defined by the network, signaled by the network entities 105-a, 105-b, or any combination thereof. Additionally, or alternatively, the UE 115-a may utilize the next earliest available resource to perform the deprioritized communication.

For example, if the UE 115-a prioritizes a PDCCH message (e.g., downlink communication 210) based on a prioritization rule, a PUCCH message (e.g., uplink communication 215) may be deprioritized, and the UE 115-a may defer transmission of the PUCCH message to the next earliest slot that can accommodate the PUCCH message by checking slot by slot. By way of another example, if a prioritization rule deprioritizes an SPS occasion (e.g., downlink communication 210), the network entity 105-a may defer the SPS occasion to the next earliest slot that can accommodate the SPS occasion by checking slot by slot. Moreover, the UE 115-a may defer monitoring for the SPS occasion and may similarly check slot by slot to determine when to monitor and expect the deferred SPS occasion.

In some implementations, a restriction on downlink and uplink channel multiplexing may be disabled for specific pairs of channels or specific pairs of communications/reference signals. In other words, downlink and uplink channel multiplexing may be enabled for specific downlink/uplink channel pairs, for specific pairs of signals or reference signals, and the like. In some aspects, the network or network entities 105-a, 105-b may indicate whether any pair of downlink and uplink channels (or pair of signals or reference signals) can be scheduled/configured in a full-duplex mode (e.g., used for downlink and uplink channel multiplexing). Additionally, or alternatively, the network or network entities 105-a, 105-b may indicate whether any beam pairs of downlink and uplink beams may be used for downlink and uplink channel multiplexing.

For example, the first network entity 105-a, the second network entity 105-b, or both, may transmit control signaling which indicates that an indicated downlink channel (or indicated downlink reference signal) and an indicated uplink channel (or indicated uplink reference signal) are enabled for downlink and uplink channel multiplexing (e.g., restriction on downlink/uplink channel multiplexing disabled for the indicated downlink/uplink channels).

Downlink channels (or downlink reference signals) which may be enabled for downlink and uplink channel multiplexing may include an SSB, a PDCCH, a PDSCH (e.g., dynamic grant (DG) PDSCH, SPS PDSCH), a CSI-RS, a downlink PRS, or any combination thereof. A CSI-RS may include a periodic, semi-persistent, or aperiodic CSI-RS for channel state feedback, beam management, tracking reference signal, radio resource management, beam failure detection, candidate beams, physical layer reference signals, L1-RSRP, L1-SINR, radio link monitoring, or any combination thereof. Similarly, uplink channels (or uplink reference signals) which may be enabled for downlink and uplink channel multiplexing may include PUCCH, PUSCH (e.g., DG PUSCH, configured grant (CG) PUSCH), PRACH (e.g., dynamically scheduled PRACH, configured PRACH), SRS (e.g., periodic, semi-persistent, or aperiodic SRS for beam management (BM), antenna switching (AS), codebook (CB) or non-codebook (NCB) based, uplink transmission), uplink PRS, or any combination thereof.

In some aspects, the pairs of downlink/uplink channels (or pairs of downlink/uplink reference signals) which are enabled for downlink and uplink channel multiplexing for full-duplex may be limited or restricted to certain use cases. For example, a pair of downlink/uplink channels may be enabled for downlink/uplink channel multiplexing for a full-duplex mode at one or more of the wireless devices, or for partial or full spatial division multiplexing-based full-duplex. By way of another example, a pair of downlink/uplink channels may be enabled for downlink/uplink channel multiplexing for intra-operator communications, inter-operator communications on shared or adjacent spectrum, for operations with or without legacy UEs 115, for specified resources (e.g., specified frequency range, bands, or band combinations, such as FR2 only), for indicated full-duplex UEs 115 (e.g., relaying UEs 115), for indicated network entities 105 (e.g., full-duplex network entities 105, either defined in spec or according to UE capability).

Techniques described herein may enable the UEs 115-a to be configured with prioritization rules which enable the UE 115-a and network entities 105-a, 105-b to determine whether the UE 115-a is to prioritize downlink or uplink communications in cases where the UE 115-a is configured or scheduled to perform a downlink communication 210 and an overlapping uplink communication 215. As such, techniques described herein may resolve ambiguities as to which communications are to be performed when the UE 115-a operating in a half-duplex mode is configured or scheduled to perform overlapping uplink and downlink communications. Moreover, techniques described herein may enable the network to perform downlink and uplink channel multiplexing (e.g., lift restrictions which prevent downlink/uplink channel multiplexing), which may enable network entities 105-a, 105-b to operate in a full-duplex mode even in cases where the UE 115-a operates in a half-duplex mode. Further, by enabling the network to perform downlink and uplink channel multiplexing, techniques described herein may improve resource utilization in the wireless communications system 200, for example, by enabling BWPs to be fully utilized at network entities 105-a, 105-b for performing overlapping downlink and uplink communications.

FIG. 3 illustrates an example of a resource configuration 300 that supports prioritization rules for uplink and downlink channels in full-duplex systems in accordance with one or more aspects of the present disclosure. Aspects of the resource configuration 300 may implement, or be implemented by, aspects of the wireless communications system 100, the wireless communications system 200, or both. In particular, the resource configuration 300 illustrates resource allocation schemes 305-a, 305-b including prioritization rules which may be used by wireless devices (e.g., UEs 115, network entities 105) to determine whether a UE 115 is to prioritize downlink or uplink communications.

As shown in the first resource allocation scheme 305-a, a UE 115 may be configured with a set of downlink SSBs 310 (e.g., first SSB 310-a, second SSB 310-b, third SSB 310-c, fourth SSB 310-d), and a set of uplink CG occasions (e.g., first CG occasion 315-a, second CG occasion 315-b, third CG occasion 315-c, fourth CG occasion 315-d). In some cases, the respective SSBs 310 and the CG occasions 315 may be configured or scheduled in the same symbols or symbol periods. For example, the first SSB 310-a and the first CG occasion 315-a may be scheduled in a first symbol period, and the second SSB 310-b and the second CG occasion 315-b may be scheduled in a second symbol period.

As noted previously herein, in cases where the UE 115 is configured to operate in a half-duplex mode, the UE 115 may be unable to perform the overlapping downlink and uplink communications in each respective symbol period. As such, for each symbol period, the UE 115 may be configured to apply a prioritization rule to determine whether to prioritize (e.g., perform) the SSB 310 or the CG occasion 315 in each symbol period. In this regard, prioritization rules may be defined for downlink and uplink channels (e.g., downlink and uplink reference signals) within the same symbols or symbol periods. Stated differently, prioritization rules may be applied on a symbol-by-symbol basis.

For example, when an SSB 310 is multiplexed with an uplink signal (e.g., CG occasion 315) on the same symbol/symbol period which is enabled for downlink/uplink channel multiplexing (e.g., restriction on downlink/uplink channel multiplexing relaxed or disabled) for a full-duplex network entity 105, the uplink signal (e.g., CG occasion 315) may be prioritized if the SSB 310 is not indicated by the network entity 105 for measurement. Stated differently, if an SSB 310 is indicated for measurement and is scheduled in a same symbol period as an uplink signal, the SSB 310 may be prioritized. Conversely, if an SSB 310 is not indicated for measurement and is scheduled on a same symbol period as an uplink signal, the uplink signal may be prioritized.

For example, referring to the first resource allocation scheme 305-a, the second SSB 310-b and the third SSB 310-c may be indicated for measurement (e.g., usable by the UE 115 for measurement), whereas the first SSB 310-a and the fourth SSB 310-d may not be indicated for measurement. In this example, a prioritization rule may cause the UE 115 to prioritize the first CG occasion 315-a and the fourth CG occasion 315-d based on the first SSB 310-a and the fourth SSB 310-d not being indicated for measurement. As such, the UE 115 may transmit uplink signals using the first CG occasion 315-a and the fourth CG occasion 315-d, and refrain from receiving or monitoring the first SSB 310-a and the fourth SSB 310-d. Comparatively, the prioritization rule may cause the UE 115 to prioritize the second SSB 310-b and the third SSB 310-c based on the second and third SSBs 310 being indicated for measurement. As such, the UE 115 may monitor and receive the second SSB 310-b and the third SSB 310-c transmit uplink signals using the first CG occasion 315-a and the fourth CG occasion 315-d, and refrain from transmitting uplink signals using the second CG occasion 315-b and the third CG occasion 315-c.

Reference will now be made to the second resource allocation scheme 305-b. As shown in the second resource allocation scheme 305-b, a UE 115 may be configured with a set of downlink SSBs 310 (e.g., first SSB 310-e, second SSB 310-f, third SSB 310-g, fourth SSB 310-h). The UE 115 may additionally receive a DCI 320 which schedules an uplink DG occasion 325. As shown in FIG. 3, the DG occasion 325 may be scheduled in a same symbol or symbol period as the third SSB 310-g. Moreover, the DG occasion 325 may be scheduled relative to the DCI 320 based on a scheduling offset 330. The scheduling offset 330 may define a time interval between an end of the DCI 320 and a start of the DG occasion 325.

In some implementations, a prioritization rule may cause the UE 115 to prioritize an uplink signal which is dynamically scheduled with a scheduling offset that is no less than a minimum threshold (e.g., minimum K2). For example, as shown in the second resource allocation scheme 305-b, a prioritization rule may cause the UE 115 to prioritize the DG occasion 325 over the third SSB 310-g if the scheduling offset 330 satisfies (e.g., is greater than or equal to) a minimum threshold time duration (e.g., greater than or equal to a minimum K2 value). Comparatively, the prioritization rule may cause the UE 115 to prioritize the third SSB 310-g over the DG occasion 325 if the scheduling offset 330 fails to satisfy (e.g., is less than) the minimum threshold time duration (e.g., less than the minimum K2 value). In this regard, the prioritization rule may cause the UE 115 to prioritize the DG occasion 325 if the scheduling offset provides the UE 115 with sufficient time to process the DCI 320 prior to the scheduled DG occasion 325.

FIG. 4 illustrates an example of a resource configuration 400 that supports prioritization rules for uplink and downlink channels in full-duplex systems in accordance with one or more aspects of the present disclosure. Aspects of the resource configuration 400 may implement, or be implemented by, aspects of the wireless communications system 100, the wireless communications system 200, the resource configuration 300, or any combination thereof. In particular, the resource configuration 400 illustrates a resource allocation scheme 405 including a prioritization rule which may be used by wireless devices (e.g., UEs 115, network entities 105) to determine whether a UE 115 is to prioritize downlink or uplink communications.

As shown in the resource allocation scheme 405, a UE 115 may receive a DCI 410 which schedules one or more downlink communications, such as a first PDSCH 415-a, a second PDSCH 415-b, and a third PDSCH 415-c. In some cases, the PDSCHs 415 may include repetitions of the same downlink message. That is, the DCI 410 may indicate a repetition configuration for a downlink message, where the repetition configuration includes multiple repetitions (e.g., first PDSCH 415-a, second PDSCH 415-b, third PDSCH 415-c) of the same downlink message (e.g., repetitions of same downlink payload). Additionally, or alternatively, the PDSCHs 415 may be associated with different downlink messages or payloads. In some cases, the PDSCHs 415 may be scheduled relative to the DCI 410 based on a scheduling offset 425. The scheduling offset 425 may define a time interval between an end of the DCI 410 and a start of the first PDSCH 415-a.

Moreover, the UE 115 may be configured or scheduled with a set of uplink ROs 420 (e.g., first RO 420-a, second RO 420-b, third RO 420-c). In some cases, the respective PDSCHs 415 and the ROs 420 may be configured or scheduled in the same symbols or symbol periods. For example, the first PDSCH 415-a and the first RO 420-a may be scheduled in a first symbol period. Similarly, the second PDSCH 415-b and the second RO 420-b may be scheduled in a second symbol period, and the third PDSCH 415-c and the third RO 420-c may be scheduled in a third symbol period.

As noted previously herein, in cases where the UE 115 is configured to operate in a half-duplex mode, the UE 115 may be unable to perform the overlapping downlink and uplink communications in each respective symbol period. As such, for each symbol period, the UE 115 may be configured to apply a prioritization rule to determine whether to prioritize (e.g., perform) the PDSCH 415 or the RO 420 in each symbol period. In this regard, prioritization rules may be defined for downlink and uplink channels (e.g., downlink and uplink reference signals) within the same symbols or symbol periods. Stated differently, prioritization rules may be applied on a symbol-by-symbol basis.

For example, when a PDSCH 415 is scheduled to be performed in a same symbol or symbol period as a RO 420, a prioritization rule may prioritize the PDSCH if no RACH message is transmitted by the UE 115 within the overlapping RO 420, otherwise the RO 420 is prioritized. Further, in order for a respective DG PDSCH 415 to be prioritized over an overlapping RO 420, the corresponding scheduling offset 425 may be required to satisfy (e.g., be greater than or equal to) a threshold time interval (e.g., KO value).

For instance, a prioritization rule may cause the UE 115 to prioritize the first PDSCH 415-a over the overlapping first RO 420-a if the UE 115 will not transmit a RACH message within the first RO 420-a and if the scheduling offset 425 is greater than or equal to a KO value. Comparatively, if the UE 115 will transmit a RACH message within the first RO 420-a, and/or if the scheduling offset 425 is less than the KO value, the prioritization rule may cause the UE 115 to prioritize the first RO 420-a over the first PDSCH 415-a.

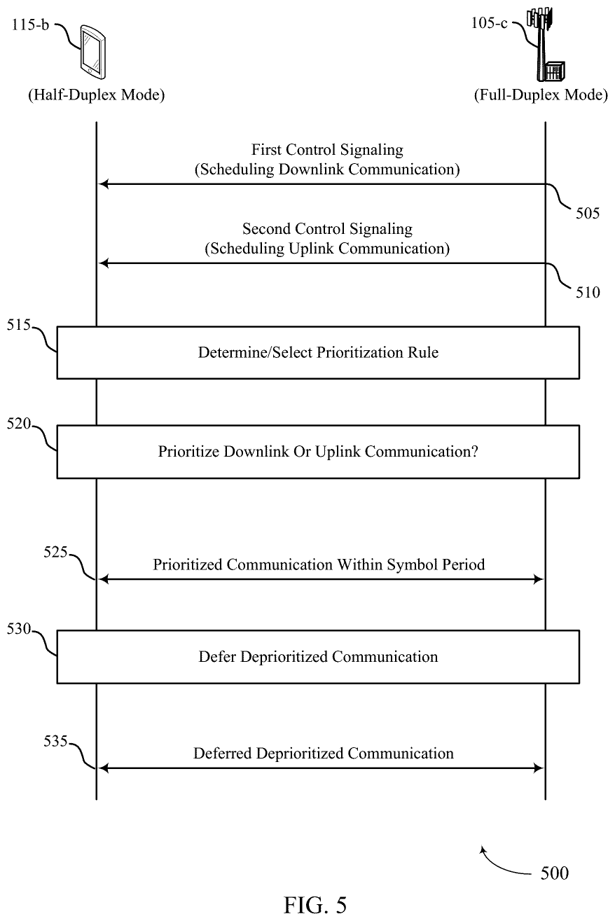

FIG. 5 illustrates an example of a process flow 500 that supports prioritization rules for uplink and downlink channels in full-duplex systems in accordance with one or more aspects of the present disclosure. Aspects of the process flow 500 may implement, or be implemented by, aspects of the wireless communications system 100, the wireless communications system 200, the resource configuration 300, the resource configuration 400, or any combination thereof. In particular, the process flow 500 illustrates a UE 115-b being scheduled with overlapping downlink and uplink communications, and applying a prioritization rule to determine whether the UE 115-b is to perform the downlink communication or the uplink communication, as described with reference to FIGS. 1-4, among other aspects.

The process flow 500 may include a UE 115-b and a network entity 105-c, which may be examples of UEs 115 and network entities 105 as described with reference to FIGS. 1-4. For example, the UE 115-b illustrated in FIG. 5 may be an example of the UE 115-a illustrated in FIG. 2. Similarly, the network entity 105-c illustrated in FIG. 5 may be an example of the network entity 105-a, the network entity 105-c, or both, as illustrated in FIG. 2.

In some examples, the operations illustrated in process flow 500 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

In some aspects, the network entity 105-c may be configured to operate in a full-duplex mode, and the UE 115-b may be configured to operate in a half-duplex mode. Moreover, a restriction on uplink and downlink channel multiplexing may be disabled (e.g., relaxed, lifted) based on the network entity 105-c operating in the full-duplex mode. That is, the network entity 105-c may be enabled or otherwise allowed to configure/schedule overlapping uplink and downlink communications based on the restriction being disabled (e.g., perform downlink and uplink channel multiplexing).

At 505, the network entity 105-c may output (e.g., transmit), to the UE 115-b, first control signaling indicating a downlink communication scheduled from the network entity 105-c to the UE 115-b during a symbol period. In other words, the UE 115-b may obtain (e.g., receive) first control signaling which schedules a downlink communication from the network entity 105-c to the UE 115-b during a symbol period. In some aspects, the UE 115-b may be configured to operate in a half-duplex mode during the symbol period. The first control signaling may include an RRC message, a DCI message, a MAC-CE message, and the like.

At 510, the network entity 105-c may output (e.g., transmit), to the UE 115-b, second control signaling indicating an uplink communication scheduled from the UE 115-b to the network entity 105-c during the symbol period. In other words, the UE 115-b may obtain (e.g., receive) second control signaling which schedules an uplink communication from the UE 115-a to the network entity 105-c during the symbol period. In this regard, the downlink message scheduled via the first control signaling at 505 and the uplink message scheduled via the second control signaling at 510 may at least partially overlap in the time domain. Moreover, as described previously herein, a restriction on uplink and downlink channel multiplexing may be disabled during at least the symbol period. The second control signaling may include an RRC message, a DCI message, a MAC-CE message, and the like.

While the first control signaling at 505 and the second control signaling at 510 are shown and described as including separate signaling or messages, this is not to be regarded as a limitation of the present disclosure, unless noted otherwise herein. For example, in some implementations, the downlink message and the uplink message may be scheduled via a single control message (e.g., single RRC message, single DCI message).

In some cases, the first control signaling, the second control signaling, additional control signaling, or any combination thereof, may indicate one or more prioritization rules associated with the half-duplex mode at the UE 115-b (e.g., associated with a restriction on uplink and downlink channel multiplexing being disabled). The one or more prioritization rules may include configurations, rules, or conditions that are usable to resolve conflicts between overlapping downlink and uplink communications in cases where downlink and uplink channel multiplexing is enabled. In other words, the first control signaling and/or the second control signaling may indicate one or more prioritization rules which indicate whether the UE 115-b is to perform downlink communications or the uplink communications which are scheduled in the same symbol period. In this regard, one or more prioritization rules may be usable to determine whether the UE 115-b is to perform (e.g., prioritize) the downlink communication scheduled via the first control signaling at 505 or the downlink communication scheduled via the second control signaling at 510.

Additionally, or alternatively, the UE 115-b may be configured (e.g., pre-configured) with the one or more prioritization rules. Stated differently, the UE 115-b may be configured with one or more prioritization rules usable for resolving conflicts between overlapping uplink and downlink communications without explicit signaling from the network entity 105-c.

At 515, the UE 115-b, the network entity 105-c, or both, may determine (e.g., identify, select) a prioritization rule which is to be applied to resolve the conflict between the downlink communication and the uplink communication. In other words, the prioritization rule may be applied by or associated with a UE 115 configured to operate in a half-duplex mode being scheduled to receive a downlink communication and transmit an uplink communication during a same symbol period (e.g., at a same time). In some aspects, the UE 115-b and/or the network entity 105-c may determine which prioritization rule is to be applied based on receiving/transmitting the first control signaling at 505, receiving/transmitting the second control signaling at 510, or both. For example, the UE 115-b may select a prioritization rule from a set of prioritization rules which were indicated via the first control signaling and/or the second control signaling.

In cases where the UE 115-b is configured with multiple candidate/available prioritization rules, the UE 115-a and/or the network entity 105-c may determine or select which prioritization rule is to be applied. For example, the first network entity 105-c may configure the UE 115-b with a set of candidate prioritization rules, and may subsequently indicate which prioritization rule is to be applied. In this example, the prioritization rule that is to be applied (e.g., prioritization decision) is indicated via explicit signaling (e.g., network entity 105-c indicates the prioritization rule via RRC, MAC-CE, or DCI).

In additional or alternative implementations, which prioritization rule is to be used may be left up to UE 115-b implementation. That is, the UE 115-a may select a prioritization rule from a set of candidate/available prioritization rules which will be used to resolve the conflict between the downlink communication and the uplink communication scheduled in the same symbol period. In such cases, the UE 115-a may indicate to the network entity 105-c which prioritization rule is selected, or the network entity 105-c may determine which prioritization rule was selected (e.g., whether the UE 115-b prioritized the downlink communication or the uplink communication) based on feedback or subsequent communications received from the UE 115-b.

The UE 115-b may be configured to select which prioritization rule will be applied based on any number of characteristics or parameters.

Characteristics/parameters which may be used to select a prioritization rule from a set of candidate/available prioritization rules may include, but are not limited to, types of communications associated with the scheduled downlink/uplink communications, priorities (e.g., QoS requirements) associated with the scheduled downlink/uplink communications, channels associated with the scheduled downlink/uplink communications, a relative timing between the scheduled downlink/uplink communications, resource types associated with the scheduled downlink/uplink communications, a relative timing at which the downlink/uplink communications were scheduled, repetition configurations associated with the scheduled downlink/uplink communications, time/frequency/spatial resources associated with the scheduled downlink/uplink communications, or any combination thereof.

At 520, the UE 115-b, the network entity 105-c, or both, may determine which of the downlink communication or the uplink communication is to be prioritized based on the determined/selected prioritization rule (e.g., apply the prioritization rule). The UE 115-b and/or the network entity 105-c may determine which communication to prioritize at 520 based on receiving/transmitting the first control signaling at 505, receiving/transmitting the second control signaling at 510, determining/selecting the prioritization rule at 515, or any combination thereof.

As described previously herein, prioritization rules may be used to determine relative priorities between overlapping downlink and uplink communications in order to resolve scheduling conflicts between such communications. Prioritization rules may determine or indicate relative priorities between the downlink communication and the uplink communication based on any number of parameters, including the channels for the downlink and uplink communications, relative priorities of the downlink and uplink communications (e.g., QoS requirements), the types of downlink and uplink communications, a relative timing between the downlink and uplink communications, repetition configurations associated with the downlink and uplink communications, and the like.

For example, in some cases, the selected prioritization rule may be used to determine which of the downlink or uplink communication will be prioritized based on channel or reference signal properties associated with the downlink communication, the uplink communication, or both (e.g., channel type, reference signal type). By way of another example, in some cases, the selected prioritization rule may be used to determine which of the downlink or uplink communication will be prioritized based on time/frequency/spatial resources associated with the downlink communication, the uplink communication, or both. For instance, the prioritization rule may indicate that signals with earlier starting/ending symbols are prioritized over signals with later starting/ending symbols.

In additional or alternative implementations, the selected prioritization rule may be used to determine which of the downlink or uplink communication will be prioritized based on channel or reference signal priorities or content associated with the downlink communication, the uplink communication, or both (e.g., channel priority/content, reference signal priority/content). For example, the prioritization rule may indicate that a signal with a higher QoS requirement (e.g., shorter delay budget, lower PER requirement, etc.) is prioritized over a signal with a lower QoS requirement. In other cases, the selected prioritization rule may prioritize control signals over data signals, or vice versa. Moreover, in some implementations, the prioritization rule may be used to determine which of the downlink or uplink communication will be prioritized based on traffic arrival times of the respective signals (e.g., Signal A is prioritized if Signal B has no arrived traffic, otherwise Signal B is prioritized), and/or based on a relative time order of scheduling information associated with the respective signals (e.g., relative order in which the signals are scheduled).

Prioritization rules are described in further detail with respect to FIGS. 3 and 4 above.

At 525, the UE 115-b and the network entity 105-c may perform the prioritized communication within the symbol period in accordance with the prioritization rule. In particular, in cases where the downlink communication is prioritized in accordance with the prioritization rule, the network entity 105-c may output (e.g., transmit) the downlink communication, and the UE 115-b may obtain (e.g., receive) the downlink communication within the symbol period. Conversely, in cases where the uplink communication is prioritized in accordance with the prioritization rule, the UE 115-c may output (e.g., transmit) the uplink communication, and the network entity 105-c may obtain (e.g., receive) the uplink communication within the symbol period.

In this regard, the UE 115-b and the network entity 105-c may perform the prioritized communication (e.g., either the downlink communication or the uplink communication) at 525 based on receiving/transmitting the first control signaling at 505, receiving/transmitting the second control signaling at 510, determining/selecting the prioritization rule at 515, applying the prioritization rule at 520, or any combination thereof.

In some aspects, there are several actions or rules the UE 115-b and/or the network entity 105-c may apply for the deprioritized signal (e.g., signal with lower priority based on the prioritization rule). Actions for the deprioritized signal may include, but are not limited to, the UE 115-b and/or the network entity 105-c dropping the deprioritized signal, performing a subset of the deprioritized signal, deferring the deprioritized signal to an available future resource, or any combination thereof.

For example, in cases where the UE 115-b prioritizes the downlink communication, the UE 115-b may drop the deprioritized uplink communication by refraining from transmitting the deprioritized uplink communication. By way of another example, in cases where the UE 115-b prioritizes the uplink communication, the UE 115-b may drop the deprioritized downlink communication by refraining from monitoring for and/or refraining from decoding the deprioritized uplink communication. In some cases, the UE 115-b may be configured to drop only a portion of the deprioritized communication, such as a portion of the deprioritized communication which overlaps in the time domain with the prioritized communication. In some cases, whether the UE 115-b completely or only partially drops the deprioritized communication may be based on the channel type(s) and/or reference signal type(s) associated with the respective downlink communication and the uplink communication.

In cases where the UE 115-b completely or partially drops (e.g., refrains from receiving/monitoring for) the downlink communication, such as PDSCH messages or CSI-RSs, there are several implementations for handling feedback (e.g., ACK/NACK) associated with the dropped downlink communication. In accordance with a first implementation, upon completely or partially dropping the downlink communication, the UE 115-b may refrain from transmitting any feedback bits (e.g., no ACK/NACK bit is transmitted). Comparatively, in accordance with a second implementation, upon completely or partially dropping the downlink communication, the UE 115-b may transmit a NACK bit. In some cases, whether the UE 115-b utilizes the first or second implementation may depend on a HARQ-ACK codebook type. For example, the UE 115-b may utilize the first implementation (e.g., no ACK/NACK bit transmitted) for Type 1 codebook communications, and may utilize the second implementation (e.g., NACK bit transmitted) for Type 2 codebook communications. Moreover, such implementations associated with feedback for dropped downlink communications may be applied for PDSCH messages, as well as other types of downlink signals, such as for providing CSI reports (uplink) in response to dropped CSI-RSs.

In additional or alternative implementations, the deprioritized communication may be deferred to later time resources. In such cases, the process flow 500 may proceed to 530.

At 530, the UE 115-b, the network entity 105-c, or both, may defer the deprioritized communication to a future available resource. The future available resource may be configured (e.g., pre-configured) by the network entity 105-c, defined by the network, signaled by the network entity 105-c, or any combination thereof. Additionally, or alternatively, the UE 115-b may utilize the next earliest available resource to perform the deprioritized communication.

For example, if the UE 115-b prioritizes a PDCCH message (e.g., downlink communication) based on the prioritization rule, a PUCCH message (e.g., uplink communication) may be deprioritized, and the UE 115-a may defer transmission of the PUCCH message to the next earliest slot that can accommodate the PUCCH message by checking slot by slot. By way of another example, if a prioritization rule deprioritizes an SPS occasion (e.g., downlink communication), the network entity 105-c may defer the SPS occasion to the next earliest slot that can accommodate the SPS occasion by checking slot by slot. Moreover, the UE 115-b may defer monitoring for the SPS occasion and may similarly check slot by slot to determine when to monitor and expect the deferred SPS occasion.

At 535, the UE 115-b and the network entity 105-c may perform the deprioritized communication which was deferred to a later time resource at 535. In particular, in cases where the downlink communication is deprioritized in accordance with the prioritization rule and deferred at 530, the network entity 105-c may output (e.g., transmit) the downlink communication, and the UE 115-b may obtain (e.g., receive) the downlink communication within a later time resource which is configured or signaled by the network. Conversely, in cases where the uplink communication is deprioritized in accordance with the prioritization rule and deferred at 530, the UE 115-c may output (e.g., transmit) the uplink communication, and the network entity 105-c may obtain (e.g., receive) the uplink communication within a later time resource which is configured or signaled by the network.

In this regard, the UE 115-b and the network entity 105-c may perform the deprioritized communication (e.g., either the downlink communication or the uplink communication) at 525 based on receiving/transmitting the first control signaling at 505, receiving/transmitting the second control signaling at 510, determining/selecting the prioritization rule at 515, applying the prioritization rule at 520, performing the prioritized communication at 525, deferring the deprioritized communication at 530, or any combination thereof.

Techniques described herein may enable the UE 115-b to be configured with prioritization rules which enable the UE 115-b and network entity 105-c to determine whether the UE 115-b is to prioritize downlink or uplink communications in cases where the UE 115-b is configured or scheduled to perform overlapping downlink and uplink communications. As such, techniques described herein may resolve ambiguities as to which communications are to be performed when the UE 115-b operating in a half-duplex mode is configured or scheduled to perform overlapping uplink and downlink communications. Moreover, techniques described herein may enable the network to perform downlink and uplink channel multiplexing within the same time resources, which may enable the network entity 105-c to operate in a full-duplex mode even in cases where the UE 115-b operates in a half-duplex mode. Further, by enabling the network to perform downlink and uplink channel multiplexing (e.g., lift restrictions which prevent downlink/uplink channel multiplexing), techniques described herein may improve resource utilization in the wireless communications system, for example, by enabling BWPs to be fully utilized at the network entity 105-c for performing overlapping downlink and uplink communications.

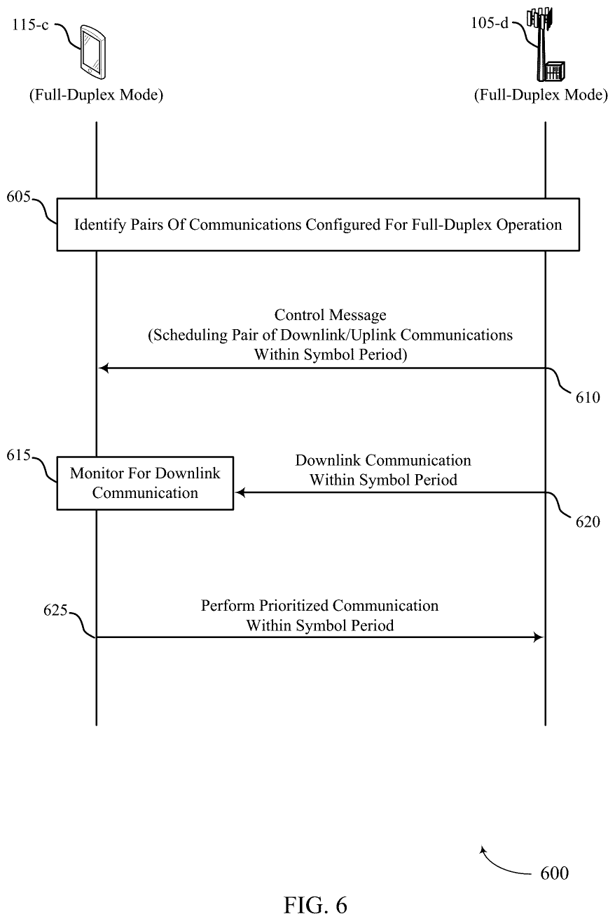

FIG. 6 illustrates an example of a process flow 600 that supports prioritization rules for uplink and downlink channels in full-duplex systems in accordance with one or more aspects of the present disclosure. Aspects of the process flow 600 may implement, or be implemented by, aspects of the wireless communications system 100, the wireless communications system 200, the resource configuration 300, the resource configuration 400, the process flow 500, or any combination thereof. In particular, the process flow 600 illustrates a UE 115-c identifying pairs of uplink/downlink communications which may be scheduled in a same symbol period based on a full-duplex mode, and performing a scheduled pair of uplink/downlink communications within a same symbol period, as described with reference to FIGS. 1-4, among other aspects.

The process flow 600 may include a UE 115-c and a network entity 105-d, which may be examples of UEs 115 and network entities 105 as described with reference to FIGS. 1-5. For example, the UE 115-c illustrated in FIG. 6 may be an example of the UE 115-a illustrated in FIG. 2. Similarly, the network entity 105-d illustrated in FIG. 6 may be an example of the network entity 105-a, the network entity 105-b, or both, as illustrated in FIG. 2.

In some examples, the operations illustrated in process flow 600 may be performed by hardware (e.g., including circuitry, processing blocks, logic components, and other components), code (e.g., software) executed by a processor, or any combination thereof. Alternative examples of the following may be implemented, where some steps are performed in a different order than described or are not performed at all. In some cases, steps may include additional features not mentioned below, or further steps may be added.

In some aspects, the UE 115-c and the network entity 105-d may be configured to operate in a full-duplex mode. Moreover, a restriction on uplink and downlink channel multiplexing may be disabled (e.g., relaxed, lifted) based on the network entity 105-d operating in the full-duplex mode. That is, the network entity 105-d may be enabled or otherwise allowed to configure/schedule overlapping uplink and downlink communications based on the restriction being disabled (e.g., perform downlink and uplink channel multiplexing).

At 605, the UE 115-c, the network entity 105-d, or both, may identify one or more pairs of communications which are configured for full-duplex communications. In some aspects, each pair of communications may include a downlink communication and an uplink communication that may be scheduled in a same symbol period in cases where uplink and downlink channel multiplexing is enabled for the respective symbol period.

In other words, the UE 115-c and/or the network entity 105-d may identify pairs of communications which are enabled for full-duplex communications. Stated differently, in some implementations, a restriction on downlink and uplink channel multiplexing may be disabled for specific pairs of channels or specific pairs of communications/reference signals. In other words, downlink and uplink channel multiplexing may be enabled for specific downlink/uplink channel pairs, for specific pairs of signals or reference signals, and the like.

In some aspects, the network or entity 105-d may indicate whether any pair of downlink and uplink channels (or pair of signals or reference signals) can be scheduled/configured in a full-duplex mode (e.g., used for downlink and uplink channel multiplexing). For example, in some cases, the network entity 105-d may output (e.g., transmit) control signaling to the UE 115-c indicating one or more pairs of communications which are configured for full-duplex communications. In such cases, the UE 115-c may identify the pairs of communications which are enabled for full-duplex communications based on the control signaling from the network entity 105-d.

Additionally, or alternatively, the UE 115-c, the network entity 105-d, or both may determine whether any beam pairs of downlink and uplink beams may be used for downlink and uplink channel multiplexing (e.g., downlink/uplink beams enabled for full-duplex communications). For example, the network entity 105-d may output (e.g., transmit) control signaling which indicates that an indicated downlink channel (or indicated downlink reference signal) and an indicated uplink channel (or indicated uplink reference signal) are enabled for downlink and uplink channel multiplexing (e.g., restriction on downlink/uplink channel multiplexing disabled for the indicated downlink/uplink channels).

Downlink channels (or downlink reference signals) which may be enabled for downlink and uplink channel multiplexing may include an SSB, a PDCCH, a PDSCH (e.g., DG-PDSCH, SPS PDSCH), a CSI-RS, a downlink PRS, or any combination thereof. A CSI-RS may include a periodic, semi-persistent, or aperiodic CSI-RS for channel state feedback, beam management, tracking reference signal, radio resource management, beam failure detection, candidate beams, physical layer reference signals, L1-RSRP, L1-SINR, radio link monitoring, or any combination thereof. Similarly, uplink channels (or uplink reference signals) which may be enabled for downlink and uplink channel multiplexing may include PUCCH, PUSCH (e.g., DG PUSCH, CG-PUSCH), PRACH (e.g., dynamically scheduled PRACH, configured PRACH), SRS (e.g., periodic, semi-persistent, or aperiodic SRS for beam management, antenna switching, codebook or non-codebook based, uplink transmission), uplink PRS, or any combination thereof.

In some aspects, the pairs of downlink/uplink channels (or pairs of downlink/uplink reference signals) which are enabled for downlink and uplink channel multiplexing for full-duplex may be limited or restricted to certain use cases. For example, a pair of downlink/uplink channels may be enabled for downlink/uplink channel multiplexing for a full-duplex mode at one or more of the wireless devices, or for partial or full spatial division multiplexing-based full-duplex. By way of another example, a pair of downlink/uplink channels may be enabled for downlink/uplink channel multiplexing for intra-operator communications, inter-operator communications on shared or adjacent spectrum, for operations with or without legacy UEs 115, for specified resources (e.g., specified frequency range, bands, or band combinations, such as FR2 only), for indicated full-duplex UEs 115 (e.g., relaying UEs 115), for indicated network entities 105 (e.g., full-duplex network entities 105, either defined in spec or according to UE capability).

At 610, the network entity 105-d may output (e.g., transmit) a control message scheduling a pair of communications during a symbol period, where the pair of communications includes a downlink communication and an uplink communication. In particular, the control message may schedule a pair of communications which were identified as being configured/enabled for full-duplex communications at 605. The control message may include a DCI message, an RRC message, a MAC-CE, or any combination thereof. Moreover, in some cases, the downlink communication and the uplink communication included within the pair of communications may be scheduled by separate control messages.

At 615, the UE 115-c may monitor for the downlink communication which was scheduled during the symbol period via the control message at 610. In particular, the UE 115-c may monitor for the downlink communication based on operating in the full-duplex mode. Moreover, the UE 115-c may monitor for the downlink communication based on identifying the pair(s) of communications configured for full-duplex operations at 605.

At 620, the network entity 105-d may output (e.g., transmit) the downlink communication within the symbol period. Similarly, the UE 115-b may obtain (e.g., receive) the downlink communication within the symbol period. The network entity 105-d and the UE 115-c may transmit/receive the downlink communication at 620 based on identifying the pair(s) of communications configured for full-duplex operations at 605, transmitting/receiving the control message scheduling the pair of communications at 610, monitoring for the downlink communication at 615, or any combination thereof.

At 625, the UE 115-c may output (e.g., transmit) the uplink communication within the symbol period. Similarly, the network entity 105-d may obtain (e.g., receive) the uplink communication within the symbol period. The UE 115-c and the network entity 105-d may transmit/receive the uplink communication at 625 based on identifying the pair(s) of communications configured for full-duplex operations at 605, transmitting/receiving the control message scheduling the pair of communications at 610, monitoring for the downlink communication at 615, receiving/transmitting the downlink communication at 620, or any combination thereof.

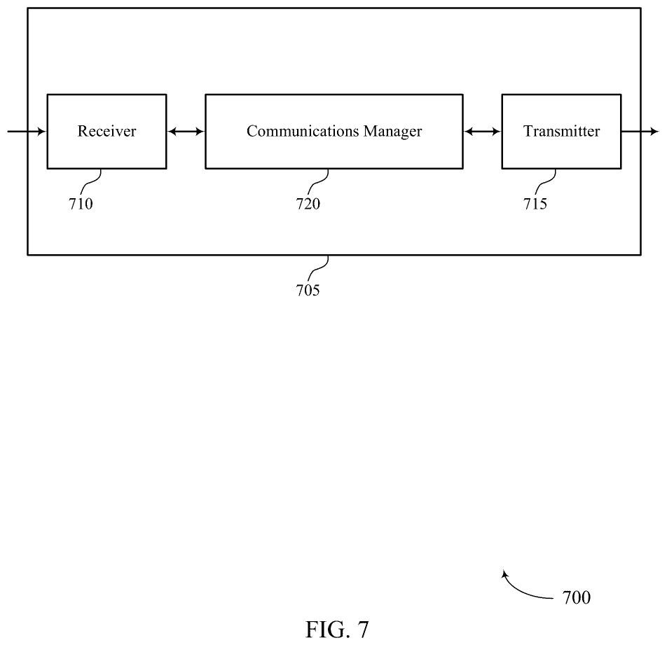

FIG. 7 shows a block diagram 700 of a device 705 that supports prioritization rules for uplink and downlink channels in full-duplex systems in accordance with one or more aspects of the present disclosure. The device 705 may be an example of aspects of a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to prioritization rules for uplink and downlink channels in full-duplex systems). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to prioritization rules for uplink and downlink channels in full-duplex systems). In some examples, the transmitter 715 may be co-located with a receiver 710 in a transceiver module. The transmitter 715 may utilize a single antenna or a set of multiple antennas.

The communications manager 720, the receiver 710, the transmitter 715, or various combinations thereof or various components thereof may be examples of means for performing various aspects of prioritization rules for uplink and downlink channels in full-duplex systems as described herein. For example, the communications manager 720, the receiver 710, the transmitter 715, or various combinations or components thereof may support a method for performing one or more of the functions described herein.

In some examples, the communications manager 720, the receiver 710, the transmitter 715, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 720, the receiver 710, the transmitter 715, or various combinations or components thereof may be implemented in code (e.g., as communications management software or firmware) executed by a processor. If implemented in code executed by a processor, the functions of the communications manager 720, the receiver 710, the transmitter 715, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 720 may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE in accordance with examples as disclosed herein. For example, the communications manager 720 may be configured as or otherwise support a means for receiving, from a network entity, first control signaling scheduling a downlink communication during a symbol period, where the UE is configured to operate in a half-duplex mode during the symbol period. The communications manager 720 may be configured as or otherwise support a means for receiving, from the network entity via the first control signaling, second control signaling, or both, an indication of an uplink communication scheduled during the symbol period. The communications manager 720 may be configured as or otherwise support a means for communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Additionally, or alternatively, the communications manager 720 may support wireless communications at a UE operating in a full-duplex mode in accordance with examples as disclosed herein. For example, the communications manager 720 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The communications manager 720 may be configured as or otherwise support a means for receiving, from a network entity, a control message scheduling the pair of communications during the symbol period. The communications manager 720 may be configured as or otherwise support a means for monitoring for the downlink communication in the full-duplex mode during the symbol period based on the control message. The communications manager 720 may be configured as or otherwise support a means for transmitting the uplink communication in the full-duplex mode during the symbol period based on the control message.

By including or configuring the communications manager 720 in accordance with examples as described herein, the device 705 (e.g., a processor controlling or otherwise coupled with the receiver 710, the transmitter 715, the communications manager 720, or a combination thereof) may support techniques which enable the UEs 115 to be configured with prioritization rules which enable the UE 115 and network entities 105-a to determine whether UEs 115 are to prioritize downlink or uplink communications in cases where the UEs 115 are configured or scheduled to perform a downlink communication and an overlapping uplink communication. As such, techniques described herein may resolve ambiguities as to which communications are to be performed when a UE 115 operating in a half-duplex mode is configured or scheduled to perform overlapping uplink and downlink communications. Moreover, techniques described herein may enable the network to perform downlink and uplink channel multiplexing (e.g., lift restrictions which prevent downlink/uplink channel multiplexing), which may enable network entities 105 to operate in a full-duplex mode even in cases where the UE 115 operates in a half-duplex mode. Further, by enabling the network to perform downlink and uplink channel multiplexing, techniques described herein may improve resource utilization in the wireless communications system, for example, by enabling BWPs to be fully utilized at network entities for performing overlapping downlink and uplink communications.

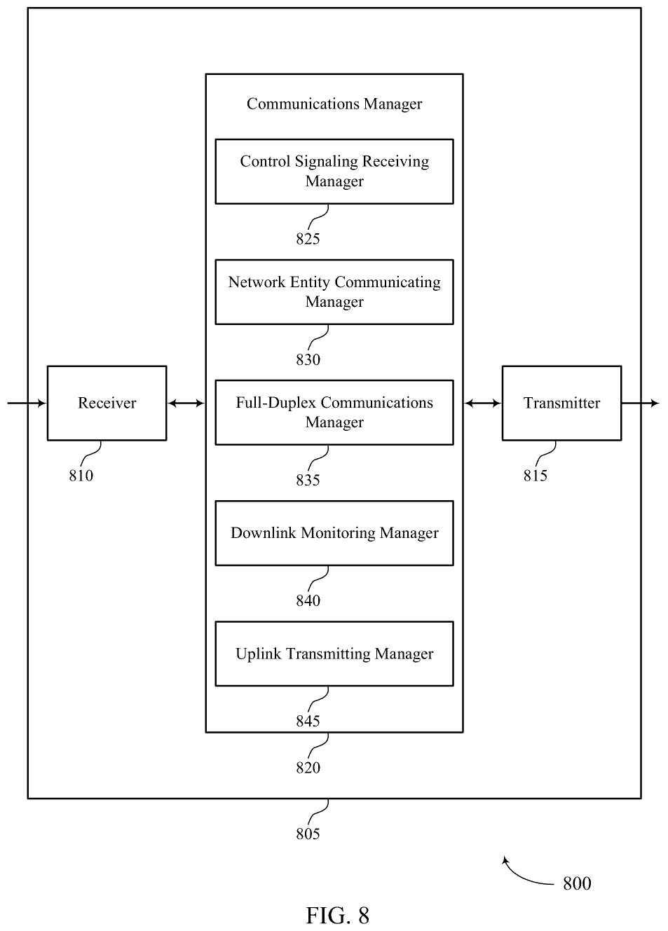

FIG. 8 shows a block diagram 800 of a device 805 that supports prioritization rules for uplink and downlink channels in full-duplex systems in accordance with one or more aspects of the present disclosure. The device 805 may be an example of aspects of a device 705 or a UE 115 as described herein. The device 805 may include a receiver 810, a transmitter 815, and a communications manager 820. The device 805 may also include a processor. Each of these components may be in communication with one another (e.g., via one or more buses).

The receiver 810 may provide a means for receiving information such as packets, user data, control information, or any combination thereof associated with various information channels (e.g., control channels, data channels, information channels related to prioritization rules for uplink and downlink channels in full-duplex systems). Information may be passed on to other components of the device 805. The receiver 810 may utilize a single antenna or a set of multiple antennas.

The transmitter 815 may provide a means for transmitting signals generated by other components of the device 805. For example, the transmitter 815 may transmit information such as packets, user data, control information, or any combination thereof associated with various information channels (e.g., control channels, data channels, information channels related to prioritization rules for uplink and downlink channels in full-duplex systems). In some examples, the transmitter 815 may be co-located with a receiver 810 in a transceiver module. The transmitter 815 may utilize a single antenna or a set of multiple antennas.

The device 805, or various components thereof, may be an example of means for performing various aspects of prioritization rules for uplink and downlink channels in full-duplex systems as described herein. For example, the communications manager 820 may include a control signaling receiving manager 825, a network entity communicating manager 830, a full-duplex communications manager 835, a downlink monitoring manager 840, an uplink transmitting manager 845, or any combination thereof. The communications manager 820 may be an example of aspects of a communications manager 720 as described herein. In some examples, the communications manager 820, or various components thereof, may be configured to perform various operations (e.g., receiving, obtaining, monitoring, outputting, transmitting) using or otherwise in cooperation with the receiver 810, the transmitter 815, or both. For example, the communications manager 820 may receive information from the receiver 810, send information to the transmitter 815, or be integrated in combination with the receiver 810, the transmitter 815, or both to obtain information, output information, or perform various other operations as described herein.

The communications manager 820 may support wireless communications at a UE in accordance with examples as disclosed herein. The control signaling receiving manager 825 may be configured as or otherwise support a means for receiving, from a network entity, first control signaling scheduling a downlink communication during a symbol period, where the UE is configured to operate in a half-duplex mode during the symbol period. The control signaling receiving manager 825 may be configured as or otherwise support a means for receiving, from the network entity via the first control signaling, second control signaling, or both, an indication of an uplink communication scheduled during the symbol period. The network entity communicating manager 830 may be configured as or otherwise support a means for communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Additionally, or alternatively, the communications manager 820 may support wireless communications at a UE operating in a full-duplex mode in accordance with examples as disclosed herein. The full-duplex communications manager 835 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The control signaling receiving manager 825 may be configured as or otherwise support a means for receiving, from a network entity, a control message scheduling the pair of communications during the symbol period. The downlink monitoring manager 840 may be configured as or otherwise support a means for monitoring for the downlink communication in the full-duplex mode during the symbol period based on the control message. The uplink transmitting manager 845 may be configured as or otherwise support a means for transmitting the uplink communication in the full-duplex mode during the symbol period based on the control message.

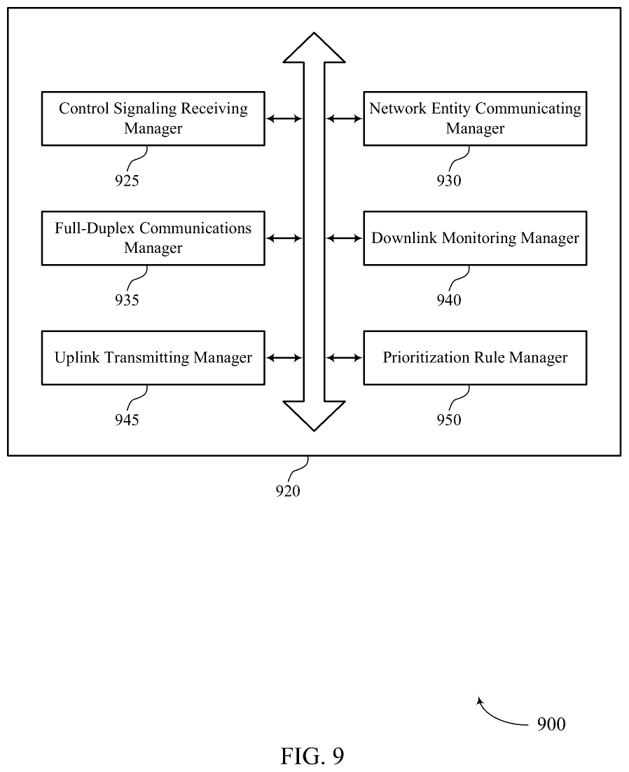

FIG. 9 shows a block diagram 900 of a communications manager 920 that supports prioritization rules for uplink and downlink channels in full-duplex systems in accordance with one or more aspects of the present disclosure. The communications manager 920 may be an example of aspects of a communications manager 720, a communications manager 820, or both, as described herein. The communications manager 920, or various components thereof, may be an example of means for performing various aspects of prioritization rules for uplink and downlink channels in full-duplex systems as described herein. For example, the communications manager 920 may include a control signaling receiving manager 925, a network entity communicating manager 930, a full-duplex communications manager 935, a downlink monitoring manager 940, an uplink transmitting manager 945, a prioritization rule manager 950, or any combination thereof. Each of these components may communicate, directly or indirectly, with one another (e.g., via one or more buses).

The communications manager 920 may support wireless communications at a UE in accordance with examples as disclosed herein. The control signaling receiving manager 925 may be configured as or otherwise support a means for receiving, from a network entity, first control signaling scheduling a downlink communication during a symbol period, where the UE is configured to operate in a half-duplex mode during the symbol period. In some examples, the control signaling receiving manager 925 may be configured as or otherwise support a means for receiving, from the network entity via the first control signaling, second control signaling, or both, an indication of an uplink communication scheduled during the symbol period. The network entity communicating manager 930 may be configured as or otherwise support a means for communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

In some examples, the prioritization rule manager 950 may be configured as or otherwise support a means for receiving the downlink communication based least in part on the prioritization rule indicating to receive the downlink communication that is a reference signal when the reference signal is scheduled in the same symbol period as the uplink communication.

In some examples, the prioritization rule manager 950 may be configured as or otherwise support a means for receiving, from the network entity, a message indicating the prioritization rule. In some examples, the prioritization rule indicates which of receiving the downlink communication or transmitting the uplink communication the UE is to perform based on a channel type, a reference signal type, or both, of the downlink communication or the uplink communication.

In some examples, the prioritization rule indicates which of receiving the downlink communication or transmitting the uplink communication the UE is to perform based on one or more resources associated with the uplink communication, the downlink communication, or both, the one or more resources corresponding to one or more time resources, one or more frequency resources, one or more spatial resource locations, or some combination thereof. In some examples, the prioritization rule indicates which of receiving the downlink communication or transmitting the uplink communication the UE is to perform based on a first priority associated with an uplink channel for the uplink communication, a second priority associated with a downlink channel for the downlink communication, or both. In some examples, the prioritization rule indicates which of receiving the downlink communication or transmitting the uplink communication the UE is to perform based on an arrival time of the downlink communication, an arrival time of the uplink communication, or both.

In some examples, the uplink transmitting manager 945 may be configured as or otherwise support a means for dropping transmission of the uplink communication or deferring transmission of the uplink communication to a future resource based on the prioritization rule.

In some examples, the prioritization rule indicates which of receiving the downlink communication or transmitting the uplink communication the UE is to perform based on a time order of scheduling information for the downlink communication relative to the uplink communication. In some examples, the prioritization rule indicates which of receiving the downlink communication or transmitting the uplink communication the UE is to perform based on a resource type associated with the symbol period. In some examples, the prioritization rule indicates which of receiving the downlink communication or transmitting the uplink communication the UE is to perform based on a repetition configuration associated with the uplink communication, the downlink communication, or both.

In some examples, the prioritization rule manager 950 may be configured as or otherwise support a means for selecting the prioritization rule from a set of multiple available prioritization rules.

In some examples, the uplink transmitting manager 945 may be configured as or otherwise support a means for transmitting the uplink communication based least in part on the prioritization rule indicating to transmit a reference signal when the uplink communication is a reference signal scheduled in the same symbol period as the downlink communication.

In some examples, the downlink monitoring manager 940 may be configured as or otherwise support a means for refraining from monitoring for at least a portion of the downlink communication based on the prioritization rule, where the at least the portion of the downlink communication overlaps with the uplink communication in a time domain. In some examples, a feedback bit associated with the downlink communication is transmitted or withheld based on the prioritization rule.

In some examples, the network entity communicating manager 930 may be configured as or otherwise support a means for deferring reception of the downlink communication to a future resource based on the prioritization rule. In some examples, the prioritization rule indicates that the uplink communication is prioritized over the downlink communication or the downlink communication is prioritized over the uplink communication.

In some examples, uplink and downlink multiplexing is enabled during the symbol period based on a restriction on uplink and downlink channel multiplexing being disabled during the symbol period. In some examples, the restriction on uplink and downlink channel multiplexing is disabled based on the network entity operating in a full-duplex mode during the symbol period.

Additionally, or alternatively, the communications manager 920 may support wireless communications at a UE operating in a full-duplex mode in accordance with examples as disclosed herein. The full-duplex communications manager 935 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. In some examples, the control signaling receiving manager 925 may be configured as or otherwise support a means for receiving, from a network entity, a control message scheduling the pair of communications during the symbol period. The downlink monitoring manager 940 may be configured as or otherwise support a means for monitoring for the downlink communication in the full-duplex mode during the symbol period based on the control message. The uplink transmitting manager 945 may be configured as or otherwise support a means for transmitting the uplink communication in the full-duplex mode during the symbol period based on the control message.

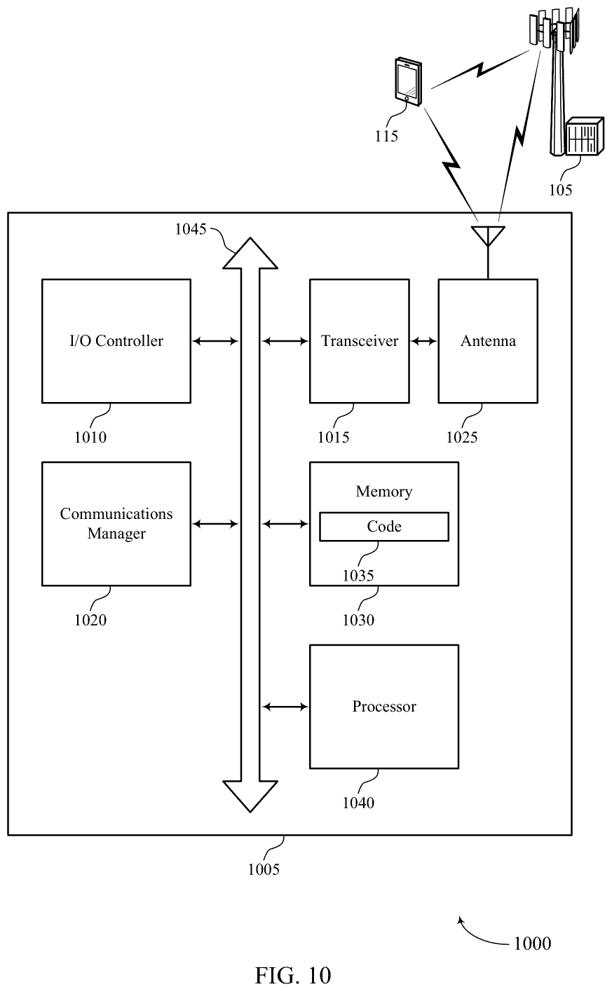

FIG. 10 shows a diagram of a system 1000 including a device 1005 that supports prioritization rules for uplink and downlink channels in full-duplex systems in accordance with one or more aspects of the present disclosure. The device 1005 may be an example of or include the components of a device 705, a device 805, or a UE 115 as described herein. The device 1005 may communicate (e.g., wirelessly) with one or more network entities 105, one or more UEs 115, or any combination thereof. The device 1005 may include components for bi-directional voice and data communications including components for transmitting and receiving communications, such as a communications manager 1020, an input/output (I/O) controller 1010, a transceiver 1015, an antenna 1025, a memory 1030, code 1035, and a processor 1040. These components may be in electronic communication or otherwise coupled (e.g., operatively, communicatively, functionally, electronically, electrically) via one or more buses (e.g., a bus 1045).

The I/O controller 1010 may manage input and output signals for the device 1005. The I/O controller 1010 may also manage peripherals not integrated into the device 1005. In some cases, the I/O controller 1010 may represent a physical connection or port to an external peripheral. In some cases, the I/O controller 1010 may utilize an operating system such as iOS®, ANDROID®, MS-DOS®, MS-WINDOWS®, OS/2®, UNIX®, LINUX®, or another known operating system. Additionally or alternatively, the I/O controller 1010 may represent or interact with a modem, a keyboard, a mouse, a touchscreen, or a similar device. In some cases, the I/O controller 1010 may be implemented as part of a processor, such as the processor 1040. In some cases, a user may interact with the device 1005 via the I/O controller 1010 or via hardware components controlled by the I/O controller 1010.

In some cases, the device 1005 may include a single antenna 1025. However, in some other cases, the device 1005 may have more than one antenna 1025, which may be capable of concurrently transmitting or receiving multiple wireless transmissions. The transceiver 1015 may communicate bi-directionally, via the one or more antennas 1025, wired, or wireless links as described herein. For example, the transceiver 1015 may represent a wireless transceiver and may communicate bi-directionally with another wireless transceiver. The transceiver 1015 may also include a modem to modulate the packets, to provide the modulated packets to one or more antennas 1025 for transmission, and to demodulate packets received from the one or more antennas 1025. The transceiver 1015, or the transceiver 1015 and one or more antennas 1025, may be an example of a transmitter 715, a transmitter 815, a receiver 710, a receiver 810, or any combination thereof or component thereof, as described herein.

The memory 1030 may include random access memory (RAM) and read-only memory (ROM). The memory 1030 may store computer-readable, computer-executable code 1035 including instructions that, when executed by the processor 1040, cause the device 1005 to perform various functions described herein. The code 1035 may be stored in a non-transitory computer-readable medium such as system memory or another type of memory. In some cases, the code 1035 may not be directly executable by the processor 1040 but may cause a computer (e.g., when compiled and executed) to perform functions described herein. In some cases, the memory 1030 may contain, among other things, a basic I/O system (BIOS) which may control basic hardware or software operation such as the interaction with peripheral components or devices.

The processor 1040 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 1040 may be configured to operate a memory array using a memory controller. In some other cases, a memory controller may be integrated into the processor 1040. The processor 1040 may be configured to execute computer-readable instructions stored in a memory (e.g., the memory 1030) to cause the device 1005 to perform various functions (e.g., functions or tasks supporting prioritization rules for uplink and downlink channels in full-duplex systems). For example, the device 1005 or a component of the device 1005 may include a processor 1040 and memory 1030 coupled with or to the processor 1040, the processor 1040 and memory 1030 configured to perform various functions described herein.

The communications manager 1020 may support wireless communications at a UE in accordance with examples as disclosed herein. For example, the communications manager 1020 may be configured as or otherwise support a means for receiving, from a network entity, first control signaling scheduling a downlink communication during a symbol period, where the UE is configured to operate in a half-duplex mode during the symbol period. The communications manager 1020 may be configured as or otherwise support a means for receiving, from the network entity via the first control signaling, second control signaling, or both, an indication of an uplink communication scheduled during the symbol period. The communications manager 1020 may be configured as or otherwise support a means for communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Additionally, or alternatively, the communications manager 1020 may support wireless communications at a UE operating in a full-duplex mode in accordance with examples as disclosed herein. For example, the communications manager 1020 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The communications manager 1020 may be configured as or otherwise support a means for receiving, from a network entity, a control message scheduling the pair of communications during the symbol period. The communications manager 1020 may be configured as or otherwise support a means for monitoring for the downlink communication in the full-duplex mode during the symbol period based on the control message. The communications manager 1020 may be configured as or otherwise support a means for transmitting the uplink communication in the full-duplex mode during the symbol period based on the control message.

By including or configuring the communications manager 1020 in accordance with examples as described herein, the device 1005 may support techniques which enable the UEs 115 to be configured with prioritization rules which enable the UE 115 and network entities 105-a to determine whether UEs 115 are to prioritize downlink or uplink communications in cases where the UEs 115 are configured or scheduled to perform a downlink communication and an overlapping uplink communication. As such, techniques described herein may resolve ambiguities as to which communications are to be performed when a UE 115 operating in a half-duplex mode is configured or scheduled to perform overlapping uplink and downlink communications. Moreover, techniques described herein may enable the network to perform downlink and uplink channel multiplexing (e.g., lift restrictions which prevent downlink/uplink channel multiplexing), which may enable network entities 105 to operate in a full-duplex mode even in cases where the UE 115 operates in a half-duplex mode. Further, by enabling the network to perform downlink and uplink channel multiplexing, techniques described herein may improve resource utilization in the wireless communications system, for example, by enabling BWPs to be fully utilized at network entities for performing overlapping downlink and uplink communications.

In some examples, the communications manager 1020 may be configured to perform various operations (e.g., receiving, monitoring, transmitting) using or otherwise in cooperation with the transceiver 1015, the one or more antennas 1025, or any combination thereof. Although the communications manager 1020 is illustrated as a separate component, in some examples, one or more functions described with reference to the communications manager 1020 may be supported by or performed by the processor 1040, the memory 1030, the code 1035, or any combination thereof. For example, the code 1035 may include instructions executable by the processor 1040 to cause the device 1005 to perform various aspects of prioritization rules for uplink and downlink channels in full-duplex systems as described herein, or the processor 1040 and the memory 1030 may be otherwise configured to perform or support such operations.

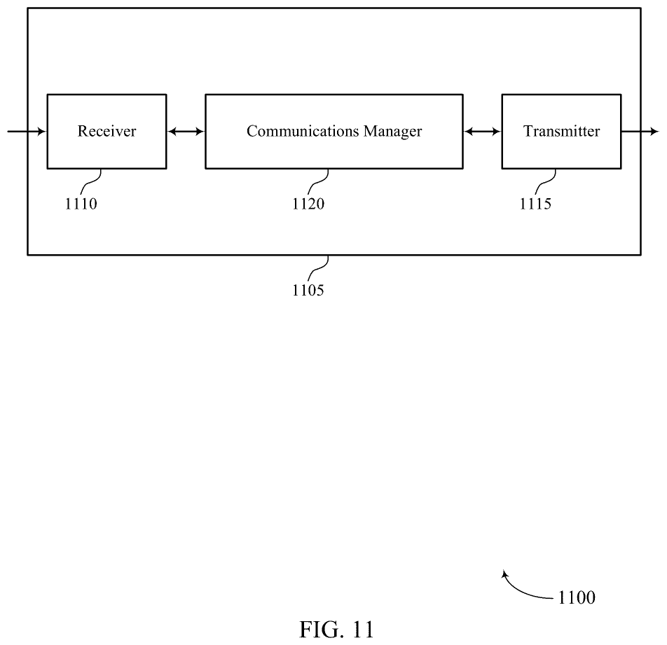

FIG. 11 shows a block diagram 1100 of a device 1105 that supports prioritization rules for uplink and downlink channels in full-duplex systems in accordance with one or more aspects of the present disclosure. The device 1105 may be an example of aspects of a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The communications manager 1120, the receiver 1110, the transmitter 1115, or various combinations thereof or various components thereof may be examples of means for performing various aspects of prioritization rules for uplink and downlink channels in full-duplex systems as described herein. For example, the communications manager 1120, the receiver 1110, the transmitter 1115, or various combinations or components thereof may support a method for performing one or more of the functions described herein.

In some examples, the communications manager 1120, the receiver 1110, the transmitter 1115, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1120, the receiver 1110, the transmitter 1115, or various combinations or components thereof may be implemented in code (e.g., as communications management software or firmware) executed by a processor. If implemented in code executed by a processor, the functions of the communications manager 1120, the receiver 1110, the transmitter 1115, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1120 may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity in accordance with examples as disclosed herein. For example, the communications manager 1120 may be configured as or otherwise support a means for transmitting, to a UE, first control signaling scheduling a downlink communication during a symbol period. The communications manager 1120 may be configured as or otherwise support a means for transmitting, to the UE via the first control signaling, second control signaling, or both, an indication of an uplink communication scheduled during the symbol period. The communications manager 1120 may be configured as or otherwise support a means for transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period. The communications manager 1120 may be configured as or otherwise support a means for communicating with the UE during the symbol period via one of the downlink communication or the uplink communication based on the prioritization rule.

Additionally, or alternatively, the communications manager 1120 may support wireless communications at a network entity in accordance with examples as disclosed herein. For example, the communications manager 1120 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The communications manager 1120 may be configured as or otherwise support a means for transmitting, to a UE operating in a full-duplex mode, a control message scheduling the pair of communications during the symbol period. The communications manager 1120 may be configured as or otherwise support a means for transmitting, to the UE, the downlink communication during the symbol period based on the control message. The communications manager 1120 may be configured as or otherwise support a means for monitoring for the uplink communication during the symbol period based on the control message.

By including or configuring the communications manager 1120 in accordance with examples as described herein, the device 1105 (e.g., a processor controlling or otherwise coupled with the receiver 1110, the transmitter 1115, the communications manager 1120, or a combination thereof) may support techniques which enable the UEs 115 to be configured with prioritization rules which enable the UE 115 and network entities 105-a to determine whether UEs 115 are to prioritize downlink or uplink communications in cases where the UEs 115 are configured or scheduled to perform a downlink communication and an overlapping uplink communication. As such, techniques described herein may resolve ambiguities as to which communications are to be performed when a UE 115 operating in a half-duplex mode is configured or scheduled to perform overlapping uplink and downlink communications. Moreover, techniques described herein may enable the network to perform downlink and uplink channel multiplexing (e.g., lift restrictions which prevent downlink/uplink channel multiplexing), which may enable network entities 105 to operate in a full-duplex mode even in cases where the UE 115 operates in a half-duplex mode. Further, by enabling the network to perform downlink and uplink channel multiplexing, techniques described herein may improve resource utilization in the wireless communications system, for example, by enabling BWPs to be fully utilized at network entities for performing overlapping downlink and uplink communications.

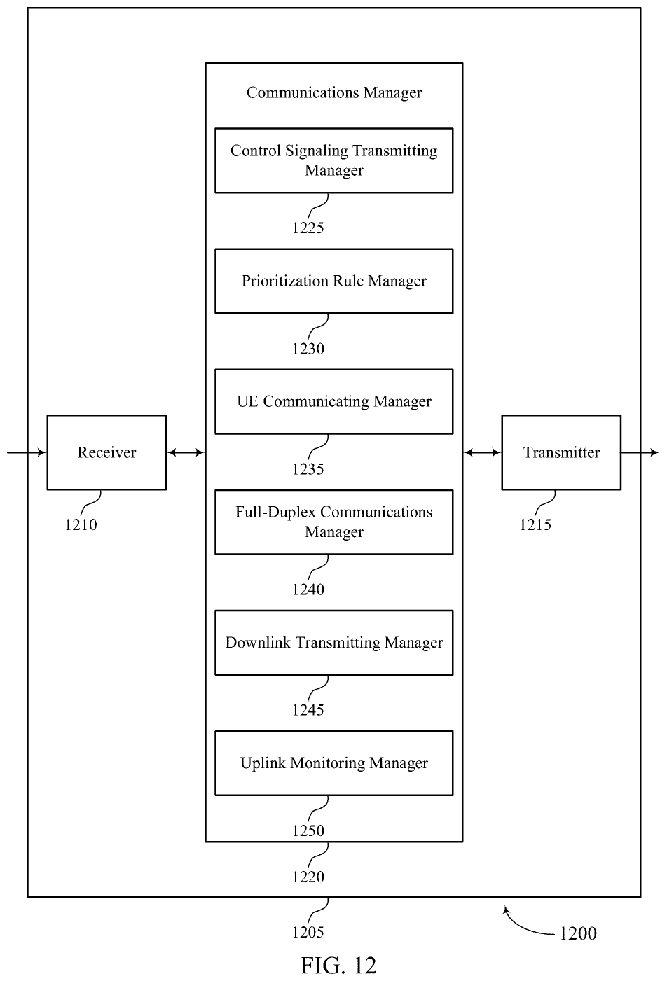

FIG. 12 shows a block diagram 1200 of a device 1205 that supports prioritization rules for uplink and downlink channels in full-duplex systems in accordance with one or more aspects of the present disclosure. The device 1205 may be an example of aspects of a device 1105 or a network entity 105 as described herein. The device 1205 may include a receiver 1210, a transmitter 1215, and a communications manager 1220. The device 1205 may also include a processor. Each of these components may be in communication with one another (e.g., via one or more buses).

The receiver 1210 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1205. In some examples, the receiver 1210 may support obtaining information by receiving signals via one or more antennas. Additionally, or alternatively, the receiver 1210 may support obtaining information by receiving signals via one or more wired (e.g., electrical, fiber optic) interfaces, wireless interfaces, or any combination thereof.

The transmitter 1215 may provide a means for outputting (e.g., transmitting, providing, conveying, sending) information generated by other components of the device 1205. For example, the transmitter 1215 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1215 may support outputting information by transmitting signals via one or more antennas. Additionally, or alternatively, the transmitter 1215 may support outputting information by transmitting signals via one or more wired (e.g., electrical, fiber optic) interfaces, wireless interfaces, or any combination thereof. In some examples, the transmitter 1215 and the receiver 1210 may be co-located in a transceiver, which may include or be coupled with a modem.

The device 1205, or various components thereof, may be an example of means for performing various aspects of prioritization rules for uplink and downlink channels in full-duplex systems as described herein. For example, the communications manager 1220 may include a control signaling transmitting manager 1225, a prioritization rule manager 1230, a UE communicating manager 1235, a full-duplex communications manager 1240, a downlink transmitting manager 1245, an uplink monitoring manager 1250, or any combination thereof. The communications manager 1220 may be an example of aspects of a communications manager 1120 as described herein. In some examples, the communications manager 1220, or various components thereof, may be configured to perform various operations (e.g., receiving, obtaining, monitoring, outputting, transmitting) using or otherwise in cooperation with the receiver 1210, the transmitter 1215, or both. For example, the communications manager 1220 may receive information from the receiver 1210, send information to the transmitter 1215, or be integrated in combination with the receiver 1210, the transmitter 1215, or both to obtain information, output information, or perform various other operations as described herein.

The communications manager 1220 may support wireless communications at a network entity in accordance with examples as disclosed herein. The control signaling transmitting manager 1225 may be configured as or otherwise support a means for transmitting, to a UE, first control signaling scheduling a downlink communication during a symbol period. The control signaling transmitting manager 1225 may be configured as or otherwise support a means for transmitting, to the UE via the first control signaling, second control signaling, or both, an indication of an uplink communication scheduled during the symbol period. The prioritization rule manager 1230 may be configured as or otherwise support a means for transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period. The UE communicating manager 1235 may be configured as or otherwise support a means for communicating with the UE during the symbol period via one of the downlink communication or the uplink communication based on the prioritization rule.

Additionally, or alternatively, the communications manager 1220 may support wireless communications at a network entity in accordance with examples as disclosed herein. The full-duplex communications manager 1240 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The control signaling transmitting manager 1225 may be configured as or otherwise support a means for transmitting, to a UE operating in a full-duplex mode, a control message scheduling the pair of communications during the symbol period. The downlink transmitting manager 1245 may be configured as or otherwise support a means for transmitting, to the UE, the downlink communication during the symbol period based on the control message. The uplink monitoring manager 1250 may be configured as or otherwise support a means for monitoring for the uplink communication during the symbol period based on the control message.

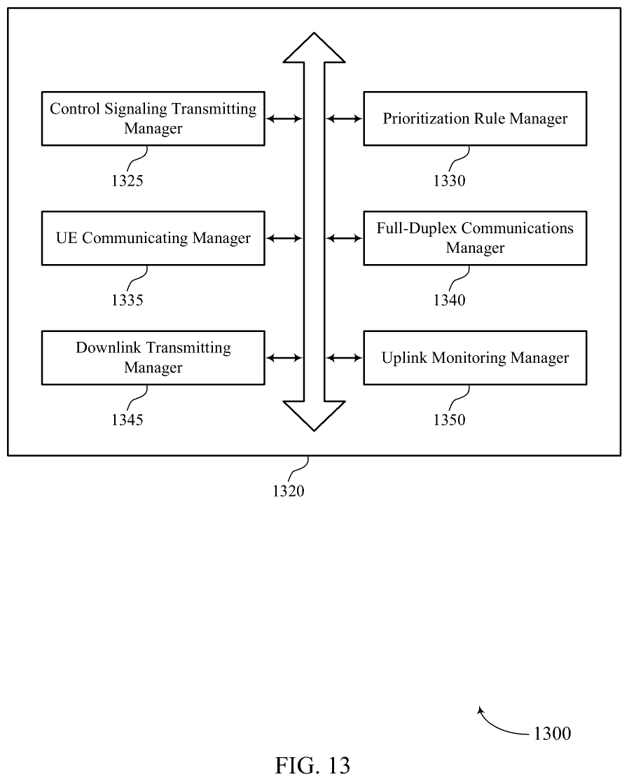

FIG. 13 shows a block diagram 1300 of a communications manager 1320 that supports prioritization rules for uplink and downlink channels in full-duplex systems in accordance with one or more aspects of the present disclosure. The communications manager 1320 may be an example of aspects of a communications manager 1120, a communications manager 1220, or both, as described herein. The communications manager 1320, or various components thereof, may be an example of means for performing various aspects of prioritization rules for uplink and downlink channels in full-duplex systems as described herein. For example, the communications manager 1320 may include a control signaling transmitting manager 1325, a prioritization rule manager 1330, a UE communicating manager 1335, a full-duplex communications manager 1340, a downlink transmitting manager 1345, an uplink monitoring manager 1350, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1320 may support wireless communications at a network entity in accordance with examples as disclosed herein. The control signaling transmitting manager 1325 may be configured as or otherwise support a means for transmitting, to a UE, first control signaling scheduling a downlink communication during a symbol period. In some examples, the control signaling transmitting manager 1325 may be configured as or otherwise support a means for transmitting, to the UE via the first control signaling, second control signaling, or both, an indication of an uplink communication scheduled during the symbol period. The prioritization rule manager 1330 may be configured as or otherwise support a means for transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period. The UE communicating manager 1335 may be configured as or otherwise support a means for communicating with the UE during the symbol period via one of the downlink communication or the uplink communication based on the prioritization rule.

In some examples, the prioritization rule indicates whether the UE is to receive the downlink communication or transmit the uplink communication based on a channel type, a reference signal type, or both, of the downlink communication or the uplink communication. In some examples, the prioritization rule indicates whether the UE is to receive the downlink communication or transmit the uplink communication based on one or more resources associated with the uplink communication, the downlink communication, or both, the one or more resources corresponding to one or more time resources, one or more frequency resources, one or more spatial resource locations, or some combination thereof.

In some examples, the prioritization rule indicates whether the UE is to receive the downlink communication or transmit the uplink communication based on a first priority associated with an uplink channel for the uplink communication, a second priority associated with a downlink channel for the downlink communication, or both. In some examples, the prioritization rule indicates whether the UE is to receive the downlink communication or transmit the uplink communication based on an arrival time of the downlink communication, an arrival time of the uplink communication, or both.

In some examples, the prioritization rule indicates whether the UE is to receive the downlink communication or transmit the uplink communication based on a resource type associated with the symbol period. In some examples, the prioritization rule indicates whether the UE is to receive the downlink communication or transmit the uplink communication based on a repetition configuration associated with the uplink communication, the downlink communication, or both.

In some examples, the prioritization rule indicates whether the UE is to receive the downlink communication or transmit the uplink communication based on a time order of scheduling information for the downlink communication and the uplink communication. In some examples, the prioritization rule indicates that the uplink communication is prioritized over the downlink communication or the downlink communication is prioritized over the uplink communication.

Additionally, or alternatively, the communications manager 1320 may support wireless communications at a network entity in accordance with examples as disclosed herein. The full-duplex communications manager 1340 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. In some examples, the control signaling transmitting manager 1325 may be configured as or otherwise support a means for transmitting, to a UE operating in a full-duplex mode, a control message scheduling the pair of communications during the symbol period. The downlink transmitting manager 1345 may be configured as or otherwise support a means for transmitting, to the UE, the downlink communication during the symbol period based on the control message. The uplink monitoring manager 1350 may be configured as or otherwise support a means for monitoring for the uplink communication during the symbol period based on the control message.

In some examples, the uplink communication is associated with a PUCCH, a PUSCH, a PRACH, an SRS, an uplink PRS, or some combination thereof. In some examples, the downlink communication is associated with an SSB, a PDCCH, a PDSCH, a CSI-RS, a downlink PRS, or some combination thereof. In some examples, the pair of communications includes an uplink channel and a downlink channel, one or more reference signals, or some combination thereof.

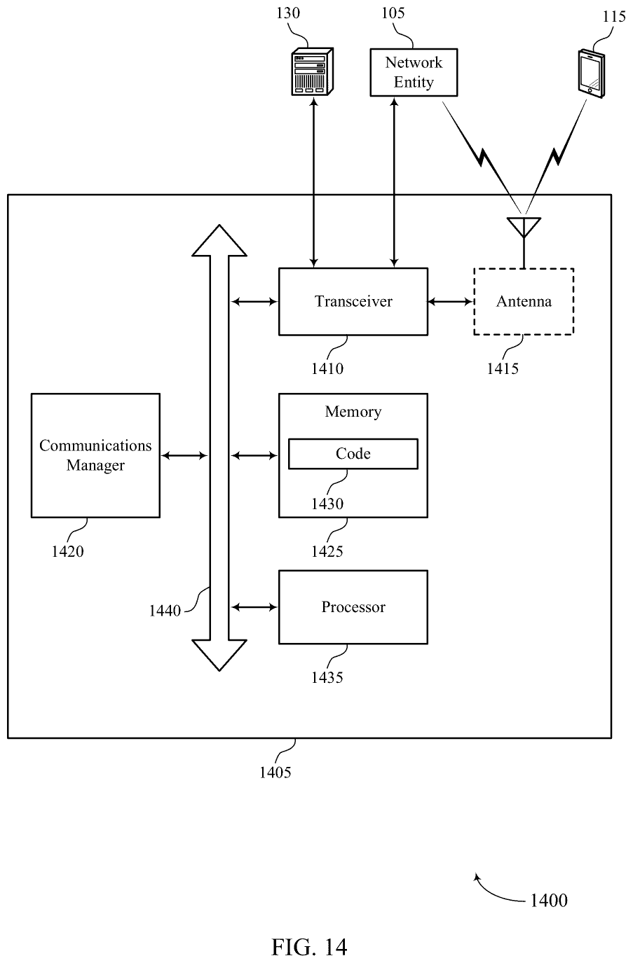

FIG. 14 shows a diagram of a system 1400 including a device 1405 that supports prioritization rules for uplink and downlink channels in full-duplex systems in accordance with one or more aspects of the present disclosure. The device 1405 may be an example of or include the components of a device 1105, a device 1205, or a network entity 105 as described herein. The device 1405 may communicate with one or more network entities 105, one or more UEs 115, or any combination thereof, which may include communications over one or more wired interfaces, over one or more wireless interfaces, or any combination thereof. The device 1405 may include components that support outputting and obtaining communications, such as a communications manager 1420, a transceiver 1410, an antenna 1415, a memory 1425, code 1430, and a processor 1435. These components may be in electronic communication or otherwise coupled (e.g., operatively, communicatively, functionally, electronically, electrically) via one or more buses (e.g., a bus 1440).

The transceiver 1410 may support bi-directional communications via wired links, wireless links, or both as described herein. In some examples, the transceiver 1410 may include a wired transceiver and may communicate bi-directionally with another wired transceiver. Additionally, or alternatively, in some examples, the transceiver 1410 may include a wireless transceiver and may communicate bi-directionally with another wireless transceiver. In some examples, the device 1405 may include one or more antennas 1415, which may be capable of transmitting or receiving wireless transmissions (e.g., concurrently). The transceiver 1410 may also include a modem to modulate signals, to provide the modulated signals for transmission (e.g., by one or more antennas 1415, by a wired transmitter), to receive modulated signals (e.g., from one or more antennas 1415, from a wired receiver), and to demodulate signals. The transceiver 1410, or the transceiver 1410 and one or more antennas 1415 or wired interfaces, where applicable, may be an example of a transmitter 1115, a transmitter 1215, a receiver 1110, a receiver 1210, or any combination thereof or component thereof, as described herein. In some examples, the transceiver may be operable to support communications via one or more communications links (e.g., a communication link 125, a backhaul communication link 120, a midhaul communication link 162, a fronthaul communication link 168).

The memory 1425 may include RAM and ROM. The memory 1425 may store computer-readable, computer-executable code 1430 including instructions that, when executed by the processor 1435, cause the device 1405 to perform various functions described herein. The code 1430 may be stored in a non-transitory computer-readable medium such as system memory or another type of memory. In some cases, the code 1430 may not be directly executable by the processor 1435 but may cause a computer (e.g., when compiled and executed) to perform functions described herein. In some cases, the memory 1425 may contain, among other things, a BIOS which may control basic hardware or software operation such as the interaction with peripheral components or devices.

The processor 1435 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1435 may be configured to operate a memory array using a memory controller. In some other cases, a memory controller may be integrated into the processor 1435. The processor 1435 may be configured to execute computer-readable instructions stored in a memory (e.g., the memory 1425) to cause the device 1405 to perform various functions (e.g., functions or tasks supporting prioritization rules for uplink and downlink channels in full-duplex systems). For example, the device 1405 or a component of the device 1405 may include a processor 1435 and memory 1425 coupled with the processor 1435, the processor 1435 and memory 1425 configured to perform various functions described herein. The processor 1435 may be an example of a cloud-computing platform (e.g., one or more physical nodes and supporting software such as operating systems, virtual machines, or container instances) that may host the functions (e.g., by executing code 1430) to perform the functions of the device 1405.

In some examples, a bus 1440 may support communications of (e.g., within) a protocol layer of a protocol stack. In some examples, a bus 1440 may support communications associated with a logical channel of a protocol stack (e.g., between protocol layers of a protocol stack), which may include communications performed within a component of the device 1405, or between different components of the device 1405 that may be co-located or located in different locations (e.g., where the device 1405 may refer to a system in which one or more of the communications manager 1420, the transceiver 1410, the memory 1425, the code 1430, and the processor 1435 may be located in one of the different components or divided between different components).

In some examples, the communications manager 1420 may manage aspects of communications with a core network 130 (e.g., via one or more wired or wireless backhaul links). For example, the communications manager 1420 may manage the transfer of data communications for client devices, such as one or more UEs 115. In some examples, the communications manager 1420 may manage communications with other network entities 105, and may include a controller or scheduler for controlling communications with UEs 115 in cooperation with other network entities 105. In some examples, the communications manager 1420 may support an X2 interface within an LTE/LTE-A wireless communications network technology to provide communication between network entities 105.

The communications manager 1420 may support wireless communications at a network entity in accordance with examples as disclosed herein. For example, the communications manager 1420 may be configured as or otherwise support a means for transmitting, to a UE, first control signaling scheduling a downlink communication during a symbol period. The communications manager 1420 may be configured as or otherwise support a means for transmitting, to the UE via the first control signaling, second control signaling, or both, an indication of an uplink communication scheduled during the symbol period. The communications manager 1420 may be configured as or otherwise support a means for transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period. The communications manager 1420 may be configured as or otherwise support a means for communicating with the UE during the symbol period via one of the downlink communication or the uplink communication based on the prioritization rule.

Additionally, or alternatively, the communications manager 1420 may support wireless communications at a network entity in accordance with examples as disclosed herein. For example, the communications manager 1420 may be configured as or otherwise support a means for identifying a pair of communications configured for full-duplex operation during a symbol period, the pair of communications including an uplink communication scheduled during the symbol period and a downlink communication scheduled during the symbol period, where uplink and downlink channel multiplexing is enabled during the symbol period. The communications manager 1420 may be configured as or otherwise support a means for transmitting, to a UE operating in a full-duplex mode, a control message scheduling the pair of communications during the symbol period. The communications manager 1420 may be configured as or otherwise support a means for transmitting, to the UE, the downlink communication during the symbol period based on the control message. The communications manager 1420 may be configured as or otherwise support a means for monitoring for the uplink communication during the symbol period based on the control message.

By including or configuring the communications manager 1420 in accordance with examples as described herein, the device 1405 may support techniques which enable the UEs 115 to be configured with prioritization rules which enable the UE 115 and network entities 105-a to determine whether UEs 115 are to prioritize downlink or uplink communications in cases where the UEs 115 are configured or scheduled to perform a downlink communication and an overlapping uplink communication. As such, techniques described herein may resolve ambiguities as to which communications are to be performed when a UE 115 operating in a half-duplex mode is configured or scheduled to perform overlapping uplink and downlink communications. Moreover, techniques described herein may enable the network to perform downlink and uplink channel multiplexing (e.g., lift restrictions which prevent downlink/uplink channel multiplexing), which may enable network entities 105 to operate in a full-duplex mode even in cases where the UE 115 operates in a half-duplex mode. Further, by enabling the network to perform downlink and uplink channel multiplexing, techniques described herein may improve resource utilization in the wireless communications system, for example, by enabling BWPs to be fully utilized at network entities for performing overlapping downlink and uplink communications.

In some examples, the communications manager 1420 may be configured to perform various operations (e.g., receiving, obtaining, monitoring, outputting, transmitting) using or otherwise in cooperation with the transceiver 1410, the one or more antennas 1415 (e.g., where applicable), or any combination thereof. Although the communications manager 1420 is illustrated as a separate component, in some examples, one or more functions described with reference to the communications manager 1420 may be supported by or performed by the processor 1435, the memory 1425, the code 1430, the transceiver 1410, or any combination thereof. For example, the code 1430 may include instructions executable by the processor 1435 to cause the device 1405 to perform various aspects of prioritization rules for uplink and downlink channels in full-duplex systems as described herein, or the processor 1435 and the memory 1425 may be otherwise configured to perform or support such operations.

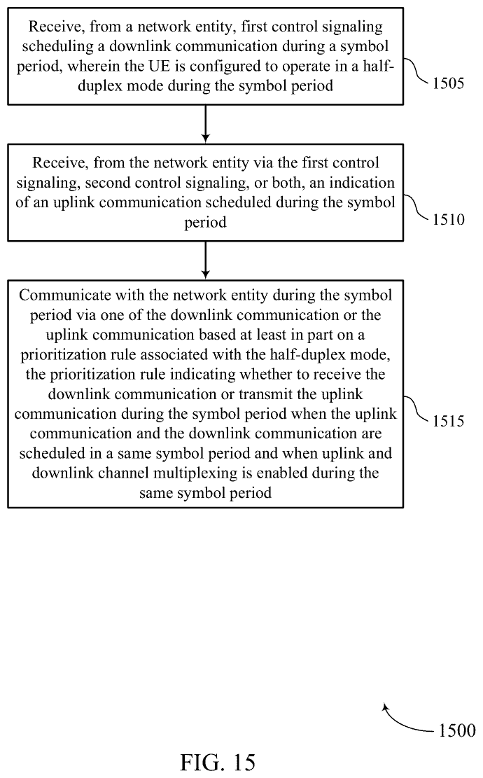

FIG. 15 shows a flowchart illustrating a method 1500 that supports prioritization rules for uplink and downlink channels in full-duplex systems in accordance with one or more aspects of the present disclosure. The operations of the method 1500 may be implemented by a UE or its components as described herein. For example, the operations of the method 1500 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1505, the method may include receiving, from a network entity, first control signaling scheduling a downlink communication during a symbol period, where the UE is configured to operate in a half-duplex mode during the symbol period. The operations of 1505 may be performed in accordance with examples as disclosed herein. In some examples, aspects of the operations of 1505 may be performed by a control signaling receiving manager 925 as described with reference to FIG. 9.

At 1510, the method may include receiving, from the network entity via the first control signaling, second control signaling, or both, an indication of an uplink communication scheduled during the symbol period. The operations of 1510 may be performed in accordance with examples as disclosed herein. In some examples, aspects of the operations of 1510 may be performed by a control signaling receiving manager 925 as described with reference to FIG. 9.

At 1515, the method may include communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period. The operations of 1515 may be performed in accordance with examples as disclosed herein. In some examples, aspects of the operations of 1515 may be performed by a network entity communicating manager 930 as described with reference to FIG. 9.

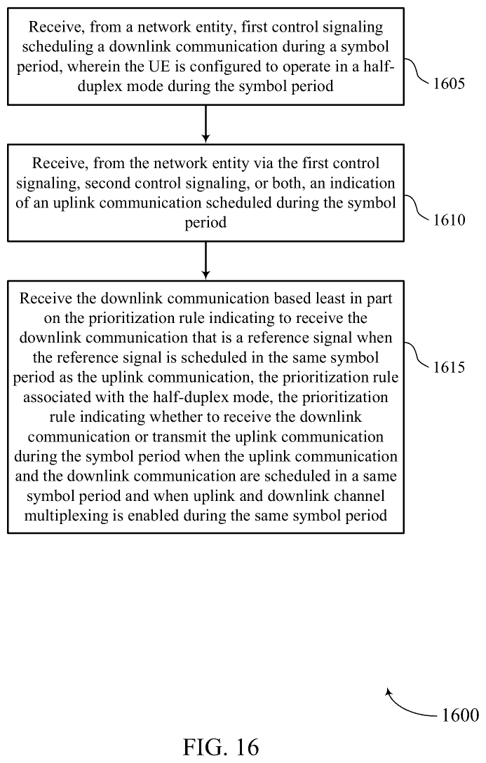

FIG. 16 shows a flowchart illustrating a method 1600 that supports prioritization rules for uplink and downlink channels in full-duplex systems in accordance with one or more aspects of the present disclosure. The operations of the method 1600 may be implemented by a UE or its components as described herein. For example, the operations of the method 1600 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1605, the method may include receiving, from a network entity, first control signaling scheduling a downlink communication during a symbol period, where the UE is configured to operate in a half-duplex mode during the symbol period. The operations of 1605 may be performed in accordance with examples as disclosed herein. In some examples, aspects of the operations of 1605 may be performed by a control signaling receiving manager 925 as described with reference to FIG. 9.

At 1610, the method may include receiving, from the network entity via the first control signaling, second control signaling, or both, an indication of an uplink communication scheduled during the symbol period. The operations of 1610 may be performed in accordance with examples as disclosed herein. In some examples, aspects of the operations of 1610 may be performed by a control signaling receiving manager 925 as described with reference to FIG. 9.

At 1615, the method may include receiving the downlink communication based least in part on the prioritization rule indicating to receive the downlink communication that is a reference signal when the reference signal is scheduled in the same symbol period as the uplink communication, the prioritization rule associated with the half-duplex mode, the prioritization rule indicating whether to receive the downlink communication or transmit the uplink communication during the symbol period when the downlink communication and the uplink communication are scheduled in a same symbol period and when uplink and downlink channel multiplexing is enabled during the same symbol period. The operations of 1615 may be performed in accordance with examples as disclosed herein. In some examples, aspects of the operations of 1615 may be performed by a prioritization rule manager 950 as described with reference to FIG. 9.

At 1620, the method may include communicating with the network entity during the symbol period via one of the downlink communication or the uplink communication based on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period. The operations of 1620 may be performed in accordance with examples as disclosed herein. In some examples, aspects of the operations of 1620 may be performed by a network entity communicating manager 930 as described with reference to FIG. 9.

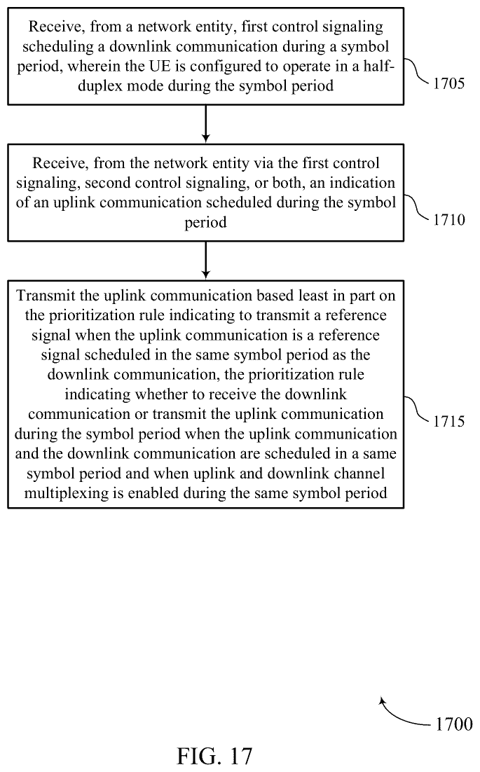

FIG. 17 shows a flowchart illustrating a method 1700 that supports prioritization rules for uplink and downlink channels in full-duplex systems in accordance with one or more aspects of the present disclosure. The operations of the method 1700 may be implemented by a UE or its components as described herein. For example, the operations of the method 1700 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 1705, the method may include receiving, from a network entity, first control signaling scheduling a downlink communication during a symbol period, where the UE is configured to operate in a half-duplex mode during the symbol period. The operations of 1705 may be performed in accordance with examples as disclosed herein. In some examples, aspects of the operations of 1705 may be performed by a control signaling receiving manager 925 as described with reference to FIG. 9.

At 1710, the method may include receiving, from the network entity via the first control signaling, second control signaling, or both, an indication of an uplink communication scheduled during the symbol period. The operations of 1710 may be performed in accordance with examples as disclosed herein. In some examples, aspects of the operations of 1710 may be performed by a control signaling receiving manager 925 as described with reference to FIG. 9.

At 1715, the method may include transmitting the uplink communication based least in part on the prioritization rule indicating to transmit a reference signal when the uplink communication is a reference signal scheduled in the same symbol period as the downlink communication, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period. The operations of 1715 may be performed in accordance with examples as disclosed herein. In some examples, aspects of the operations of 1715 may be performed by a network entity communicating manager 930 as described with reference to FIG. 9.

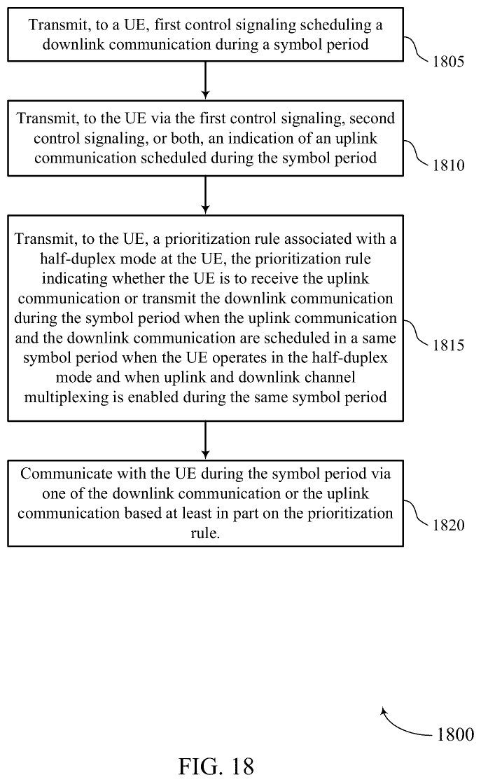

FIG. 18 shows a flowchart illustrating a method 1800 that supports prioritization rules for uplink and downlink channels in full-duplex systems in accordance with one or more aspects of the present disclosure. The operations of the method 1800 may be implemented by a network entity or its components as described herein. For example, the operations of the method 1800 may be performed by a network entity as described with reference to FIGS. 1 through 5 and 11 through 14. In some examples, a network entity may execute a set of instructions to control the functional elements of the network entity to perform the described functions. Additionally, or alternatively, the network entity may perform aspects of the described functions using special-purpose hardware.

At 1805, the method may include transmitting, to a UE, first control signaling scheduling a downlink communication during a symbol period. The operations of 1805 may be performed in accordance with examples as disclosed herein. In some examples, aspects of the operations of 1805 may be performed by a control signaling transmitting manager 1325 as described with reference to FIG. 13.

At 1810, the method may include transmitting, to the UE via the first control signaling, second control signaling, or both, an indication of an uplink communication scheduled during the symbol period. The operations of 1810 may be performed in accordance with examples as disclosed herein. In some examples, aspects of the operations of 1810 may be performed by a control signaling transmitting manager 1325 as described with reference to FIG. 13.

At 1815, the method may include transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period. The operations of 1815 may be performed in accordance with examples as disclosed herein. In some examples, aspects of the operations of 1815 may be performed by a prioritization rule manager 1330 as described with reference to FIG. 13.

At 1820, the method may include communicating with the UE during the symbol period via one of the downlink communication or the uplink communication based on the prioritization rule. The operations of 1820 may be performed in accordance with examples as disclosed herein. In some examples, aspects of the operations of 1820 may be performed by a UE communicating manager 1335 as described with reference to FIG. 13.

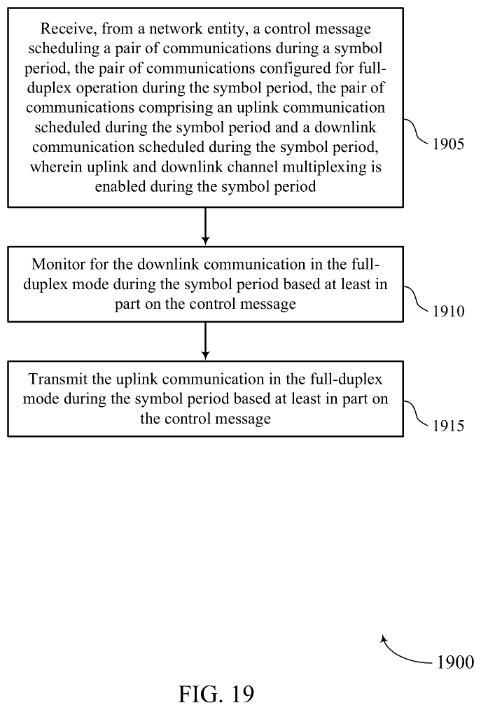

FIG. 19 shows a flowchart illustrating a method 1900 that supports prioritization rules for uplink and downlink channels in full-duplex systems in accordance with one or more aspects of the present disclosure. The operations of the method 1900 may be implemented by a UE or its components as described herein. For example, the operations of the method 1900 may be performed by a UE 115 as described with reference to FIGS. 1 through 10. In some examples, a UE may execute a set of instructions to control the functional elements of the UE to perform the described functions. Additionally, or alternatively, the UE may perform aspects of the described functions using special-purpose hardware.

At 19, the method may include receiving, from a network entity, a control message scheduling a pair of communications during a symbol period, the pair of communications configured for full-duplex operation during the symbol period, the pair of communications comprising an uplink communication scheduled during the symbol period and a downlink communication scheduled during the symbol period, where uplink and downlink channel multiplexing is enabled during the symbol period. The operations of 19 may be performed in accordance with examples as disclosed herein. In some examples, aspects of the operations of 19 may be performed by a control signaling receiving manager 925 as described with reference to FIG. 9.

At 19, the method may include monitoring for the downlink communication in the full-duplex mode during the symbol period based on the control message. The operations of 19 may be performed in accordance with examples as disclosed herein. In some examples, aspects of the operations of 19 may be performed by a downlink monitoring manager 940 as described with reference to FIG. 9.

At 19, the method may include transmitting the uplink communication in the full-duplex mode during the symbol period based on the control message. The operations of 19 may be performed in accordance with examples as disclosed herein. In some examples, aspects of the operations of 19 may be performed by an uplink transmitting manager 945 as described with reference to FIG. 9.

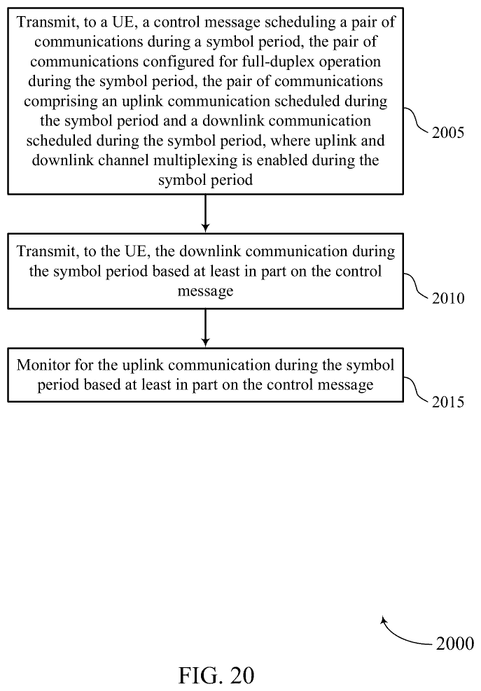

FIG. 20 shows a flowchart illustrating a method 2000 that supports prioritization rules for uplink and downlink channels in full-duplex systems in accordance with one or more aspects of the present disclosure. The operations of the method 2000 may be implemented by a network entity or its components as described herein. For example, the operations of the method 2000 may be performed by a network entity as described with reference to FIGS. 1 through 5 and 11 through 14. In some examples, a network entity may execute a set of instructions to control the functional elements of the network entity to perform the described functions. Additionally, or alternatively, the network entity may perform aspects of the described functions using special-purpose hardware.

At 20, the method may include transmitting, to a UE, a control message scheduling a pair of communications during a symbol period, the pair of communications configured for full-duplex operation during the symbol period, the pair of communications including an uplink communication scheduled during the symbol period and a downlink communication scheduled during the symbol period, where uplink and downlink channel multiplexing is enabled during the symbol period. The operations of 20 may be performed in accordance with examples as disclosed herein. In some examples, aspects of the operations of 20 may be performed by a control signaling transmitting manager 1325 as described with reference to FIG. 13.

At 20, the method may include transmitting, to the UE, the downlink communication during the symbol period based on the control message. The operations of 20 may be performed in accordance with examples as disclosed herein. In some examples, aspects of the operations of 20 may be performed by a downlink transmitting manager 1345 as described with reference to FIG. 13.

At 20, the method may include monitoring for the uplink communication during the symbol period based on the control message. The operations of 20 may be performed in accordance with examples as disclosed herein. In some examples, aspects of the operations of 20 may be performed by an uplink monitoring manager 1350 as described with reference to FIG. 13.

The following provides an overview of aspects of the present disclosure:

Aspect 1: A method for wireless communications at a UE, comprising: receiving, from a network entity, first control signaling scheduling a downlink communication during a symbol period, wherein the UE is configured to operate in a half-duplex mode during the symbol period; receiving, from the network entity via the first control signaling, second control signaling, or both, an indication of an uplink communication scheduled during the symbol period; and communicating with the network entity during the symbol period via one of the downlink communication or the uplink communication based at least in part on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

Aspect 2: The method of aspect 1, further comprising: receiving the downlink communication based least in part on the prioritization rule indicating to receive the downlink communication that is a reference signal when the reference signal is scheduled in the same symbol period as the uplink communication.

Aspect 3: The method of any of aspects 1 through 2, further comprising: receiving, from the network entity, a message indicating the prioritization rule.

Aspect 4: The method of any of aspects 1 through 3, wherein the prioritization rule indicates which of receiving the downlink communication or transmitting the uplink communication the UE is to perform based at least in part on a channel type, a reference signal type, or both, of the downlink communication or the uplink communication.

Aspect 5: The method of any of aspects 1 through 4, wherein the prioritization rule indicates which of receiving the downlink communication or transmitting the uplink communication the UE is to perform based at least in part on one or more resources associated with the uplink communication, the downlink communication, or both, the one or more resources corresponding to one or more time resources, one or more frequency resources, one or more spatial resource locations, or some combination thereof.

Aspect 6: The method of any of aspects 1 through 5, wherein the prioritization rule indicates which of receiving the downlink communication or transmitting the uplink communication the UE is to perform based at least in part on a first priority associated with an uplink channel for the uplink communication, a second priority associated with a downlink channel for the downlink communication, or both.

Aspect 7: The method of any of aspects 1 through 6, wherein the prioritization rule indicates which of receiving the downlink communication or transmitting the uplink communication the UE is to perform based at least in part on an arrival time of the downlink communication, an arrival time of the uplink communication, or both.

Aspect 8: The method of any of aspects 1 through 7, further comprising: dropping transmission of the uplink communication or deferring transmission of the uplink communication to a future resource based at least in part on the prioritization rule.

Aspect 9: The method of any of aspects 1 through 8, wherein the prioritization rule indicates which of receiving the downlink communication or transmitting the uplink communication the UE is to perform based at least in part on a time order of scheduling information for the downlink communication relative to the uplink communication.

Aspect 10: The method of any of aspects 1 through 9, wherein the prioritization rule indicates which of receiving the downlink communication or transmitting the uplink communication the UE is to perform based at least in part on a resource type associated with the symbol period.

Aspect 11: The method of any of aspects 1 through 10, wherein the prioritization rule indicates which of receiving the downlink communication or transmitting the uplink communication the UE is to perform based at least in part on a repetition configuration associated with the uplink communication, the downlink communication, or both.

Aspect 12: The method of any of aspects 1 through 11, further comprising: selecting the prioritization rule from a plurality of available prioritization rules.

Aspect 13: The method of any of aspects 1 through 12, further comprising: transmitting the uplink communication based least in part on the prioritization rule indicating to transmit a reference signal when the uplink communication is a reference signal scheduled in the same symbol period as the downlink communication.

Aspect 14: The method of aspect 13, further comprising: refraining from monitoring for at least a portion of the downlink communication based at least in part on the prioritization rule, wherein the at least the portion of the downlink communication overlaps with the uplink communication in a time domain.

Aspect 15: The method of aspect 14, wherein a feedback bit associated with the downlink communication is transmitted or withheld based at least in part on the prioritization rule.

Aspect 16: The method of any of aspects 13 through 15, further comprising: deferring reception of the downlink communication to a future resource based at least in part on the prioritization rule.

Aspect 17: The method of any of aspects 1 through 16, wherein the prioritization rule indicates that the uplink communication is prioritized over the downlink communication or the downlink communication is prioritized over the uplink communication.

Aspect 18: The method of any of aspects 1 through 17, wherein uplink and downlink multiplexing is enabled during the symbol period based at least in part on a restriction on uplink and downlink channel multiplexing being disabled during the symbol period, and the restriction on uplink and downlink channel multiplexing is disabled based at least in part on the network entity operating in a full-duplex mode during the symbol period.

Aspect 19: A method for wireless communications at a network entity, comprising: transmitting, to a UE, first control signaling scheduling a downlink communication during a symbol period; transmitting, to the UE via the first control signaling, second control signaling, or both, an indication of an uplink communication scheduled during the symbol period; transmitting, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period; and communicating with the UE during the symbol period via one of the downlink communication or the uplink communication based at least in part on the prioritization rule.

Aspect 20: The method of aspect 19, wherein the prioritization rule indicates whether the UE is to receive the downlink communication or transmit the uplink communication based at least in part on a channel type, a reference signal type, or both, of the downlink communication or the uplink communication.

Aspect 21: The method of aspect 20, wherein the prioritization rule indicates whether the UE is to receive the downlink communication or transmit the uplink communication based at least in part on one or more resources associated with the uplink communication, the downlink communication, or both, the one or more resources corresponding to one or more time resources, one or more frequency resources, one or more spatial resource locations, or some combination thereof.

Aspect 22: The method of any of aspects 20 through 21, wherein the prioritization rule indicates whether the UE is to receive the downlink communication or transmit the uplink communication based at least in part on a first priority associated with an uplink channel for the uplink communication, a second priority associated with a downlink channel for the downlink communication, or both.

Aspect 23: The method of any of aspects 20 through 22, wherein the prioritization rule indicates whether the UE is to receive the downlink communication or transmit the uplink communication based at least in part on an arrival time of the downlink communication, an arrival time of the uplink communication, or both.

Aspect 24: The method of any of aspects 20 through 23, wherein the prioritization rule indicates whether the UE is to receive the downlink communication or transmit the uplink communication based at least in part on a resource type associated with the symbol period.

Aspect 25: The method of any of aspects 20 through 24, wherein the prioritization rule indicates whether the UE is to receive the downlink communication or transmit the uplink communication based at least in part on a repetition configuration associated with the uplink communication, the downlink communication, or both.

Aspect 26: The method of any of aspects 20 through 25, wherein the prioritization rule indicates whether the UE is to receive the downlink communication or transmit the uplink communication based at least in part on a time order of scheduling information for the downlink communication and the uplink communication.

Aspect 27: The method of any of aspects 19 through 26, wherein the prioritization rule indicates that the uplink communication is prioritized over the downlink communication or the downlink communication is prioritized over the uplink communication.

Aspect 28: A method for wireless communications at a UE, comprising: receiving, from a network entity, a control message scheduling a pair of communications during a symbol period, the pair of communications configured for full-duplex operation during the symbol period the pair of communications comprising an uplink communication scheduled during the symbol period and a downlink communication scheduled during the symbol period, wherein uplink and downlink channel multiplexing is enabled during the symbol period; monitoring for the downlink communication in the full-duplex mode during the symbol period based at least in part on the control message; and transmitting the uplink communication in the full-duplex mode during the symbol period based at least in part on the control message.

Aspect 29: A method for wireless communications at a network entity, comprising: transmitting, to a UE, a control message scheduling a pair of communications during a symbol period, the pair of communications configured for full-duplex operation during the symbol period the pair of communications comprising an uplink communication scheduled during the symbol period and a downlink communication scheduled during the symbol period, wherein uplink and downlink channel multiplexing is enabled during the symbol period; transmitting, to the UE, the downlink communication during the symbol period based at least in part on the control message; and monitoring for the uplink communication during the symbol period based at least in part on the control message.

Aspect 30: The method of aspect 29, wherein the uplink communication is associated with a PUCCH, a PUSCH, a PRACH, an SRS, an uplink PRS, or some combination thereof, and the downlink communication is associated with an SSB, a PDCCH, a PDSCH, a CSI-RS, a downlink PRS, or some combination thereof.

Aspect 31: The method of any of aspects 29 through 30, wherein the pair of communications comprises an uplink channel and a downlink channel, one or more reference signals, or some combination thereof.

Aspect 32: An apparatus for wireless communications at a UE, comprising a processor; memory coupled with the processor; and instructions stored in the memory and executable by the processor to cause the apparatus to perform a method of any of aspects 1 through 18.

Aspect 33: An apparatus for wireless communications at a UE, comprising at least one means for performing a method of any of aspects 1 through 18.

Aspect 34: A non-transitory computer-readable medium storing code for wireless communications at a UE, the code comprising instructions executable by a processor to perform a method of any of aspects 1 through 18.

Aspect 35: An apparatus for wireless communications at a network entity, comprising a processor; memory coupled with the processor; and instructions stored in the memory and executable by the processor to cause the apparatus to perform a method of any of aspects 19 through 27.

Aspect 36: An apparatus for wireless communications at a network entity, comprising at least one means for performing a method of any of aspects 19 through 27.

Aspect 37: A non-transitory computer-readable medium storing code for wireless communications at a network entity, the code comprising instructions executable by a processor to perform a method of any of aspects 19 through 27.

Aspect 38: An apparatus for wireless communications at a UE operating in a full-duplex mode, comprising a processor; memory coupled with the processor; and instructions stored in the memory and executable by the processor to cause the apparatus to perform a method of any of aspects 28 through 28.

Aspect 39: An apparatus for wireless communications at a UE operating in a full-duplex mode, comprising at least one means for performing a method of any of aspects 28 through 28.

Aspect 40: A non-transitory computer-readable medium storing code for wireless communications at a UE operating in a full-duplex mode, the code comprising instructions executable by a processor to perform a method of any of aspects 28 through 28.

Aspect 41: An apparatus for wireless communications at a network entity, comprising a processor; memory coupled with the processor; and instructions stored in the memory and executable by the processor to cause the apparatus to perform a method of any of aspects 29 through 31.

Aspect 42: An apparatus for wireless communications at a network entity, comprising at least one means for performing a method of any of aspects 29 through 31.

Aspect 43: A non-transitory computer-readable medium storing code for wireless communications at a network entity, the code comprising instructions executable by a processor to perform a method of any of aspects 29 through 31.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed with a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor, but in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented in hardware, software executed by a processor, firmware, or any combination thereof. If implemented in software executed by a processor, the functions may be stored on or transmitted over as one or more instructions or code on a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one place to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc where disks usually reproduce data magnetically, while discs reproduce data optically with lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (such as receiving information), accessing (such as accessing data in a memory) and the like. Also, “determining” can include resolving, obtaining, selecting, choosing, establishing and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

What is claimed is:

1. An apparatus for wireless communications at a user equipment (UE), comprising:
a processor;
memory coupled with the processor; and
instructions stored in the memory and executable by the processor to cause the apparatus to:
receive, from a network entity, first control signaling scheduling a downlink communication during a symbol period, wherein the UE is configured to operate in a half-duplex mode during the symbol period;
receive, from the network entity via the first control signaling, second control signaling, or both, an indication of an uplink communication scheduled during the symbol period; and
communicate with the network entity during the symbol period via one of the downlink communication or the uplink communication based at least in part on a prioritization rule associated with the half-duplex mode, the prioritization rule indicating whether to receive the downlink communication or transmit the uplink communication during the symbol period when the uplink communication and the downlink communication are scheduled in a same symbol period and when uplink and downlink channel multiplexing is enabled during the same symbol period.

2. The apparatus of claim 1, wherein the instructions that are executable by the processor to cause the apparatus to communicate with the network entity during the symbol period are further executable by the processor to cause the apparatus to:
receive the downlink communication based least in part on the prioritization rule indicating to receive the downlink communication that is a reference signal when the reference signal is scheduled in the same symbol period as the uplink communication.

3. The apparatus of claim 1, wherein the instructions are further executable by the processor to cause the apparatus to:
receive, from the network entity, a message indicating the prioritization rule.

4. The apparatus of claim 1, wherein the prioritization rule indicates which of receiving the downlink communication or transmitting the uplink communication the UE is to perform based at least in part on a channel type, a reference signal type, or both, of the downlink communication or the uplink communication.

5. The apparatus of claim 1, wherein the prioritization rule indicates which of receiving the downlink communication or transmitting the uplink communication the UE is to perform based at least in part on one or more resources associated with the uplink communication, the downlink communication, or both, the one or more resources corresponding to one or more time resources, one or more frequency resources, one or more spatial resource locations, or some combination thereof.

6. The apparatus of claim 1, wherein the prioritization rule indicates which of receiving the downlink communication or transmitting the uplink communication the UE is to perform based at least in part on a first priority associated with an uplink channel for the uplink communication, a second priority associated with a downlink channel for the downlink communication, or both.

7. The apparatus of claim 1, wherein the prioritization rule indicates which of receiving the downlink communication or transmitting the uplink communication the UE is to perform based at least in part on an arrival time of the downlink communication, an arrival time of the uplink communication, or both.

8. The apparatus of claim 1, wherein the instructions are further executable by the processor to cause the apparatus to:
drop transmission of the uplink communication or defer transmission of the uplink communication to a future resource based at least in part on the prioritization rule.

9. The apparatus of claim 1, wherein the prioritization rule indicates which of receiving the downlink communication or transmitting the uplink communication the UE is to perform based at least in part on a time order of scheduling information for the downlink communication relative to the uplink communication.

10. The apparatus of claim 1, wherein the prioritization rule indicates which of receiving the downlink communication or transmitting the uplink communication the UE is to perform based at least in part on a resource type associated with the symbol period.

11. The apparatus of claim 1, wherein the prioritization rule indicates which of receiving the downlink communication or transmitting the uplink communication the UE is to perform based at least in part on a repetition configuration associated with the uplink communication, the downlink communication, or both.

12. The apparatus of claim 1, wherein the instructions are further executable by the processor to cause the apparatus to:
select the prioritization rule from a plurality of configured prioritization rules.

13. The apparatus of claim 1, wherein the instructions that are executable by the processor to cause the apparatus to communicate with the network entity during the symbol period are further executable by the processor to cause the apparatus to:
transmit the uplink communication based least in part on the prioritization rule indicating to transmit a reference signal when the uplink communication is a reference signal scheduled in the same symbol period as the downlink communication.

14. The apparatus of claim 13, wherein the instructions are further executable by the processor to cause the apparatus to:
refrain from monitoring for at least a portion of the downlink communication based at least in part on the prioritization rule, wherein the at least the portion of the downlink communication overlaps with the uplink communication in a time domain.

15. The apparatus of claim 14, wherein a feedback bit associated with the downlink communication is transmitted or withheld based at least in part on the prioritization rule.

16. The apparatus of claim 13, wherein the instructions are further executable by the processor to cause the apparatus to:
defer reception of the downlink communication to a future resource based at least in part on the prioritization rule.

17. The apparatus of claim 1, wherein the prioritization rule indicates that the uplink communication is prioritized over the downlink communication or the downlink communication is prioritized over the uplink communication.

18. The apparatus of claim 1, wherein uplink and downlink multiplexing is enabled during the symbol period based at least in part on a restriction on uplink and downlink channel multiplexing being disabled during the symbol period, and wherein the restriction on uplink and downlink channel multiplexing is disabled based at least in part on the network entity operating in a full-duplex mode during the symbol period.

19. An apparatus for wireless communications at a network entity, comprising:
a processor;
memory coupled with the processor; and
instructions stored in the memory and executable by the processor to cause the apparatus to:
transmit, to a user equipment (UE), first control signaling scheduling a downlink communication during a symbol period;
transmit, to the UE via the first control signaling, second control signaling, or both, an indication of an uplink communication scheduled during the symbol period;
transmit, to the UE, a prioritization rule associated with a half-duplex mode at the UE, the prioritization rule indicating whether the UE is to receive the uplink communication or transmit the downlink communication during the symbol period when the uplink communication and the downlink communication are scheduled in a same symbol period when the UE operates in the half-duplex mode and when uplink and downlink channel multiplexing is enabled during the same symbol period; and
communicate with the UE during the symbol period via one of the downlink communication or the uplink communication based at least in part on the prioritization rule.

20. The apparatus of claim 19, wherein the prioritization rule indicates whether the UE is to receive the downlink communication or transmit the uplink communication based at least in part on a channel type, a reference signal type, or both, of the downlink communication or the uplink communication.

21. The apparatus of claim 20, wherein the prioritization rule indicates whether the UE is to receive the downlink communication or transmit the uplink communication based at least in part on one or more resources associated with the uplink communication, the downlink communication, or both, the one or more resources corresponding to one or more time resources, one or more frequency resources, one or more spatial resource locations, or some combination thereof.

22. The apparatus of claim 20, wherein the prioritization rule indicates whether the UE is to receive the downlink communication or transmit the uplink communication based at least in part on a first priority associated with an uplink channel for the uplink communication, a second priority associated with a downlink channel for the downlink communication, or both.

23. The apparatus of claim 20, wherein the prioritization rule indicates whether the UE is to receive the downlink communication or transmit the uplink communication based at least in part on an arrival time of the downlink communication, an arrival time of the uplink communication, or both.

24. The apparatus of claim 20, wherein the prioritization rule indicates whether the UE is to receive the downlink communication or transmit the uplink communication based at least in part on a resource type associated with the symbol period.

25. The apparatus of claim 20, wherein the prioritization rule indicates whether the UE is to receive the downlink communication or transmit the uplink communication based at least in part on a repetition configuration associated with the uplink communication, the downlink communication, or both.

26. The apparatus of claim 20, wherein the prioritization rule indicates whether the UE is to receive the downlink communication or transmit the uplink communication based at least in part on a time order of scheduling information for the downlink communication and the uplink communication.

27. An apparatus for wireless communications at a user equipment (UE), comprising:
a processor;
memory coupled with the processor; and
instructions stored in the memory and executable by the processor to cause the apparatus to:
receive, from a network entity, a control message scheduling a pair of communications during a symbol period, the pair of communications configured for full-duplex operation during the symbol period, the pair of communications comprising an uplink communication scheduled during the symbol period and a downlink communication scheduled during the symbol period, wherein uplink and downlink channel multiplexing is enabled during the symbol period;
monitor for the downlink communication in a full-duplex mode during the symbol period based at least in part on the control message; and
transmit the uplink communication in the full-duplex mode during the symbol period based at least in part on the control message.

28. An apparatus for wireless communications at a network entity, comprising:
a processor;
memory coupled with the processor; and
instructions stored in the memory and executable by the processor to cause the apparatus to:
transmit, to a user equipment (UE), a control message scheduling a pair of communications during a symbol period, the pair of communications configured for full-duplex operation during the symbol period, the pair of communications comprising an uplink communication scheduled during the symbol period and a downlink communication scheduled during the symbol period, wherein uplink and downlink channel multiplexing is enabled during the symbol period;
transmit, to the UE, the downlink communication during the symbol period based at least in part on the control message; and
monitor for the uplink communication during the symbol period based at least in part on the control message.

29. The apparatus of claim 28, wherein the uplink communication is associated with a physical uplink control channel, a physical uplink shared channel, a physical random access channel, a sounding reference signal, an uplink positioning reference signal, or some combination thereof, and wherein the downlink communication is associated with a synchronization signal block, a physical downlink control channel, a physical downlink shared channel, a channel state information reference signal, a downlink positioning reference signal, or some combination thereof.

30. The apparatus of claim 28, wherein the pair of communications comprises an uplink channel and a downlink channel, one or more reference signals, or some combination thereof.
